(19) United States
(12) Patent Application Publication
(10) Pub. No.: US 2026/0180776 A1
(43) Pub. Date: Jun. 25, 2026

(54) ENERGY EFFICIENT FULL DUPLEX OPERATIONS

(71) Applicant: QUALCOMM Incorporated, San Diego, CA (US)

(72) Inventors: Muhammad Sayed Khairy ABDELGHAFFAR, San Jose, CA (US); Ahmed Attia ABOTABL, San Diego, CA (US); Hung Dinh LY, San Diego, CA (US); Abdelrahman Mohamed Ahmed Mohamed IBRAHIM, San Diego, CA (US); Wanshi CHEN, San Diego, CA (US)

(21) Appl. No.: 18/991,116

(22) Filed: Dec. 20, 2024

(51) Int. Cl. H04L 5/14; H04W 52/02; H04W 76/28

(52) U.S. Cl. CPC H04L 5/14; H04W 52/0216; H04W 76/28

(57) ABSTRACT

Various aspects of the present disclosure generally relate to wireless communication. In some aspects, a user equipment (UE) may receive, from a network node, information that indicates that a cell of the network node is operating in accordance with a subband full duplex (SBFD) mode. The UE may receive configuration information that indicates a discontinuous reception (DRX) mode associated with the cell and a discontinuous transmission (DTX) mode associated with the cell. The UE may receive control information that schedules transmission of at least one message during an SBFD time interval in accordance with the SBFD mode, where the SBFD time interval overlaps in time with one or more of a DRX inactive period associated with the DRX mode or a DTX inactive period associated with the DTX mode. The UE may communicate the at least one message in accordance with one or more SBFD message handling rules.

### FIELD OF THE DISCLOSURE

Aspects of the present disclosure generally relate to wireless communication and specifically relate to techniques, apparatuses, and methods associated with energy efficient full duplex operations.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

In some examples of wireless communications, one or more wireless devices may operate in accordance with energy saving modes. For example, cell discontinuous reception (DRX) and cell discontinuous transmission (DTX) are mechanisms employed by a network node to increase energy efficiency and resource utilization by enabling periods of inactivity in communication. Additionally, a cell of the network node may operate in accordance with a cell subband full duplex (SBFD) mode. For example, a cell SBFD configuration at a network node enables concurrent uplink and downlink transmissions within separate frequency subbands of a frequency band, enhancing spectral efficiency and network capacity. The cell SBFD configuration may be associated with the network node managing the allocation of resources dynamically or semi-statically, reducing interference between uplink and downlink operations. Additionally, the cell SBFD configuration includes interference management techniques such as power control, beamforming adjustments, and advanced self-interference cancellation to maintain reliable communication.

### SUMMARY

Some aspects described herein relate to a user equipment (UE) for wireless communication. The UE may include one or more memories and one or more processors coupled to the one or more memories. The one or more processors may be configured to receive, from a network node, information that indicates that a cell of the network node is operating in accordance with a subband full duplex (SBFD) mode. The one or more processors may be configured to receive, from the network node, configuration information that indicates a discontinuous reception (DRX) mode associated with the cell and a discontinuous transmission (DTX) mode associated with the cell. The one or more processors may be configured to receive, from the network node, control information that schedules transmission and/or reception of at least one message during an SBFD time interval in accordance with the SBFD mode, wherein the SBFD time interval at least partially overlaps in time with one or more of a DRX inactive period associated with the DRX mode or a DTX inactive period associated with the DTX mode. The one or more processors may be configured to communicate, with the network node, the at least one message in accordance with one or more SBFD message handling rules based at least in part on the SBFD time interval at least partially overlapping in time with one or more of the DRX inactive period or the DTX inactive period, wherein the one or more SBFD message handling rules are associated with the SBFD mode and one or more of the DRX mode or the DTX mode.

Some aspects described herein relate to a network node for wireless communication. The network node may include one or more memories and one or more processors coupled to the one or more memories. The one or more processors may be configured to transmit, to a UE, information that indicates that a cell of the network node is operating in accordance with an SBFD mode. The one or more processors may be configured to transmit, to the UE, configuration information that indicates a DRX mode associated with the cell and a DTX mode associated with the cell. The one or more processors may be configured to transmit, to the UE, control information that schedules transmission of at least one message during an SBFD time interval in accordance with the SBFD mode, wherein the SBFD time interval at least partially overlaps in time with one or more of a DRX inactive period associated with the DRX mode or a DTX inactive period associated with the DTX mode. The one or more processors may be configured to communicate, with the UE, the at least one message in accordance with one or more SBFD message handling rules based at least in part on the SBFD time interval at least partially overlapping in time with one or more of the DRX inactive period or the DTX inactive period, wherein the one or more SBFD message handling rules are associated with the SBFD mode and one or more of the DRX mode or the DTX mode.

Some aspects described herein relate to a method of wireless communication performed by a UE. The method may include receiving, from a network node, information that indicates that a cell of the network node is operating in accordance with an SBFD mode. The method may include receiving, from the network node, configuration information that indicates a DRX mode associated with the cell and a DTX mode associated with the cell. The method may include receiving, from the network node, control information that schedules transmission of at least one message during an SBFD time interval in accordance with the SBFD mode, wherein the SBFD time interval at least partially overlaps in time with one or more of a DRX inactive period associated with the DRX mode or a DTX inactive period associated with the DTX mode. The method may include communicating, with the network node, the at least one message in accordance with one or more SBFD message handling rules based at least in part on the SBFD time interval at least partially overlapping in time with one or more of the DRX inactive period or the DTX inactive period, wherein the one or more SBFD message handling rules are associated with the SBFD mode and one or more of the DRX mode or the DTX mode.

Some aspects described herein relate to a method of wireless communication performed by a network node. The method may include transmitting, to a UE, information that indicates that a cell of the network node is operating in accordance with an SBFD mode. The method may include transmitting, to the UE, configuration information that indicates a DRX mode associated with the cell and a DTX mode associated with the cell. The method may include transmitting, to the UE, control information that schedules transmission of at least one message during an SBFD time interval in accordance with the SBFD mode, wherein the SBFD time interval at least partially overlaps in time with one or more of a DRX inactive period associated with the DRX mode or a DTX inactive period associated with the DTX mode. The method may include communicating, with the UE, the at least one message in accordance with one or more SBFD message handling rules based at least in part on the SBFD time interval at least partially overlapping in time with one or more of the DRX inactive period or the DTX inactive period, wherein the one or more SBFD message handling rules are associated with the SBFD mode and one or more of the DRX mode or the DTX mode.

Some aspects described herein relate to a non-transitory computer-readable medium that stores a set of instructions for wireless communication by a UE. The set of instructions, when executed by one or more processors of the UE, may cause the UE to receive, from a network node, information that indicates that a cell of the network node is operating in accordance with an SBFD mode. The set of instructions, when executed by one or more processors of the UE, may cause the UE to receive, from the network node, configuration information that indicates a DRX mode associated with the cell and a DTX mode associated with the cell. The set of instructions, when executed by one or more processors of the UE, may cause the UE to receive, from the network node, control information that schedules transmission of at least one message during an SBFD time interval in accordance with the SBFD mode, wherein the SBFD time interval at least partially overlaps in time with one or more of a DRX inactive period associated with the DRX mode or a DTX inactive period associated with the DTX mode. The set of instructions, when executed by one or more processors of the UE, may cause the UE to communicate, with the network node, the at least one message in accordance with one or more SBFD message handling rules based at least in part on the SBFD time interval at least partially overlapping in time with one or more of the DRX inactive period or the DTX inactive period, wherein the one or more SBFD message handling rules are associated with the SBFD mode and one or more of the DRX mode or the DTX mode.

Some aspects described herein relate to a non-transitory computer-readable medium that stores a set of instructions for wireless communication by a network node. The set of instructions, when executed by one or more processors of the network node, may cause the network node to transmit, to a UE, information that indicates that a cell of the network node is operating in accordance with an SBFD mode. The set of instructions, when executed by one or more processors of the network node, may cause the network node to transmit, to the UE, configuration information that indicates a DRX mode associated with the cell and a DTX mode associated with the cell. The set of instructions, when executed by one or more processors of the network node, may cause the network node to transmit, to the UE, control information that schedules transmission of at least one message during an SBFD time interval in accordance with the SBFD mode, wherein the SBFD time interval at least partially overlaps in time with one or more of a DRX inactive period associated with the DRX mode or a DTX inactive period associated with the DTX mode. The set of instructions, when executed by one or more processors of the network node, may cause the network node to communicate, with the UE, the at least one message in accordance with one or more SBFD message handling rules based at least in part on the SBFD time interval at least partially overlapping in time with one or more of the DRX inactive period or the DTX inactive period, wherein the one or more SBFD message handling rules are associated with the SBFD mode and one or more of the DRX mode or the DTX mode.

Some aspects described herein relate to an apparatus for wireless communication. The apparatus may include means for receiving, from a network node, information that indicates that a cell of the network node is operating in accordance with an SBFD mode. The apparatus may include means for receiving, from the network node, configuration information that indicates a DRX mode associated with the cell and a DTX mode associated with the cell. The apparatus may include means for receiving, from the network node, control information that schedules transmission of at least one message during an SBFD time interval in accordance with the SBFD mode, wherein the SBFD time interval at least partially overlaps in time with one or more of a DRX inactive period associated with the DRX mode or a DTX inactive period associated with the DTX mode. The apparatus may include means for communicating, with the network node, the at least one message in accordance with one or more SBFD message handling rules based at least in part on the SBFD time interval at least partially overlapping in time with one or more of the DRX inactive period or the DTX inactive period, wherein the one or more SBFD message handling rules are associated with the SBFD mode and one or more of the DRX mode or the DTX mode.

Some aspects described herein relate to an apparatus for wireless communication. The apparatus may include means for transmitting, to a UE, information that indicates that a cell of the network node is operating in accordance with an SBFD mode. The apparatus may include means for transmitting, to the UE, configuration information that indicates a DRX mode associated with the cell and a DTX mode associated with the cell. The apparatus may include means for transmitting, to the UE, control information that schedules transmission of at least one message during an SBFD time interval in accordance with the SBFD mode, wherein the SBFD time interval at least partially overlaps in time with one or more of a DRX inactive period associated with the DRX mode or a DTX inactive period associated with the DTX mode. The apparatus may include means for communicating, with the UE, the at least one message in accordance with one or more SBFD message handling rules based at least in part on the SBFD time interval at least partially overlapping in time with one or more of the DRX inactive period or the DTX inactive period, wherein the one or more SBFD message handling rules are associated with the SBFD mode and one or more of the DRX mode or the DTX mode.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example of cell discontinuous transmission (DTX) and/or discontinuous reception (DRX), in accordance with the present disclosure.

FIG. 4 is a diagram illustrating an example of a DRX configuration, in accordance with the present disclosure.

FIG. 5 is a diagram illustrating examples of full-duplex communication in a wireless network, in accordance with the present disclosure.

FIG. 6 is a diagram illustrating an example of subband full duplex (SBFD) activation, in accordance with the present disclosure.

FIG. 7 is a diagram illustrating an example associated with configuring energy efficient full duplex operations, in accordance with the present disclosure.

FIG. 8 is a diagram illustrating examples associated with dropping or communicating messages associated with full duplex resources and a DRX inactive time, in accordance with the present disclosure.

FIG. 9 is a diagram illustrating example associated with conflict resolution of uplink and downlink messages associated with full duplex resources and a DRX inactive time, in accordance with the present disclosure.

FIG. 10 is a diagram illustrating examples associated with dropping or communicating messages associated with full duplex resources and a DTX inactive time, in accordance with the present disclosure.

FIG. 11 is a diagram illustrating an example associated with conflict resolution of uplink and downlink messages associated with full duplex resources and a DTX inactive time, in accordance with the present disclosure.

FIG. 12 is a diagram illustrating an example associated with energy efficient full duplex operations, in accordance with the present disclosure.

FIG. 13 is a diagram illustrating an example process performed, for example, at a user equipment (UE) or an apparatus of a UE, in accordance with the present disclosure.

FIG. 14 is a diagram illustrating an example process performed, for example, at a network node or an apparatus of a network node, in accordance with the present disclosure.

FIG. 15 is a diagram of an example apparatus for wireless communication, in accordance with the present disclosure.

FIG. 16 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some examples of wireless communications, one or more wireless devices may operate in accordance with energy saving modes. For example, cell discontinuous reception (DRX) and cell discontinuous transmission (DTX) are mechanisms employed by a network node to increase energy efficiency and resource utilization by enabling periods of inactivity in communication. These mechanisms may be useful in scenarios where the network load is variable, or user activity is intermittent. For instance, “cell DRX” refers to an ability of a network node to dynamically enable or disable a reception capability for a specific cell during pre-defined or adaptive cycles. During inactive DRX periods, the network node may not actively monitor for uplink transmissions or perform other continuous monitoring activities. Instead, the network node operates in a low-power state until a scheduled activity, such as receiving data from a user equipment (UE) or responding to uplink transmissions, is anticipated. Therefore, cell DRX conserves power and reduces interference, particularly in scenarios where the activity in the cell is sporadic or periodic. Additionally, cell DTX focuses on the transmission side, allowing the network node to cease downlink transmissions if there is no data to send or no active users in the cell. By discontinuing downlink transmissions, an inactive DTX period reduces power consumption at the network node and reduces interference to neighboring cells or UEs operating in adjacent frequencies.

Additionally, the cell of the network node may operate in accordance with a cell subband full duplex (SBFD) mode. For example, a cell SBFD configuration at a network node enables concurrent uplink and downlink transmissions within separate frequency subbands of a frequency band, enhancing spectral efficiency and network capacity. The cell SBFD configuration may be associated with the network node managing the allocation of resources dynamically or semi-statically, reducing interference between uplink and downlink operations. Additionally, the cell SBFD configuration includes interference management techniques such as power control, beamforming adjustments, and advanced self-interference cancellation to maintain reliable communication. Therefore, cell SBFD operations may be particularly beneficial in scenarios with high traffic demand or limited spectrum availability, offering improved performance between the network node and a UE.

In some cases, however, the network node and/or the UE may be unaware of how to manage wireless messages that are scheduled during SBFD symbols while the network node operates in accordance with a cell DRX mode and/or a cell DTX mode. For example, the UE may not be enabled with a UE behavior that indicates whether to drop or communicate uplink/downlink messages that are scheduled during SBFD symbols that coincide with the cell DRX inactive period and/or the cell DTX inactive period. Additionally, the UE may not be aware of a collision handling order for conflicts between uplink and downlink messages that overlap during SBFD symbols that coincide with the cell DRX inactive period and/or the cell DTX inactive period. Such lack of defined UE behavior and/or UE awareness may result in miscommunication of wireless messages between the network node and the UE, which may reduce resource utilization and increase latency associated with wireless transmissions.

Various aspects relate generally to energy efficient full duplex operations. Some aspects more specifically relate to the UE and/or the network node applying one or more SBFD message handling rules if one or more wireless messages are scheduled during SBFD symbols that coincide with the cell DRX inactive period and/or the cell DTX inactive period. In some aspects, the network node may transmit configuration information to the UE that indicates a single configuration that aligns a cell DRX mode and the cell DTX mode in time. For example, the single configuration may indicate a discontinuous transmission and reception (DXX) mode, that includes a DXX inactive period where the network node refrains from both wireless transmission and wireless reception. In some aspects, if a wireless message is scheduled during SBFD symbols that coincide with the DXX inactive period, the one or more SBFD message handling rules may indicate for the UE and/or network node to drop the wireless message based on a message type (e.g., drop semi-statically configured messages and communicate dynamically configured messages or messages that include positioning information). In some aspects, the network node may transmit configuration information to the UE that indicates separate configurations for the cell DRX mode and the cell DTX mode. If, a wireless message is scheduled during SBFD symbols that coincide with the DRX inactive period or a DTX inactive period, then the one or more SBFD message handling rules may indicate one or more cell DRX rules, one or more cell DTX rules, and/or one or more collision handling rules. Therefore, the UE may operate in accordance with the one or more SBFD message handling rules to mitigate potential collisions between uplink and downlink messages that overlap at the UE, and/or to determine which message types may be communicated during SBFD symbols that coincide with the DRX inactive period or a DTX inactive period. In some examples, the network node may transmit, and the UE may receive, configuration information that indicates one or more SBFD message handling rules. In some examples, the UE may be preconfigured with the one or more SBFD message handling rules.

Particular aspects of the subject matter described in this disclosure can be implemented to realize one or more of the following potential advantages. In some examples, the described techniques can be used to increase communication reliability between the network node and the UE. For example, the one or more SBFD message handling rules may enable the UE to determine which messages may be allowed for communication and which messages may be dropped during SBFD symbols that coincide with the DRX inactive period, the DTX inactive period, and/or the DXX inactive period. Therefore, the one or more SBFD message handling rules may enable UE behavior to efficiently drop and/or communicate wireless messages, which may increase message reliability and/or reduce message latency, while maintaining energy savings (at the UE and the network node) associated with operating in accordance with the cell DRX/DTX/DXX modes.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, subband full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

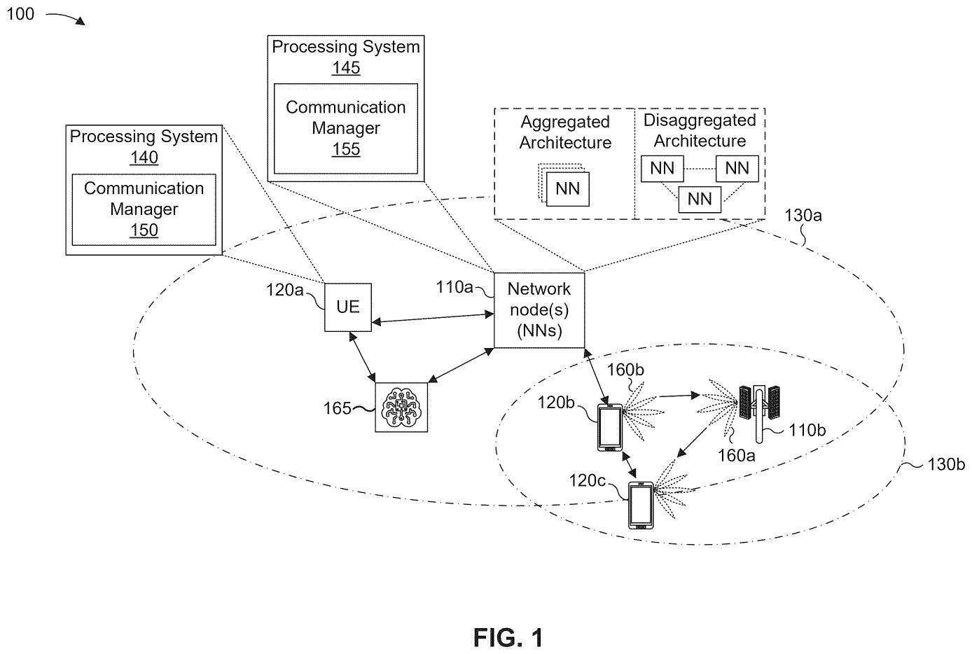

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access

procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

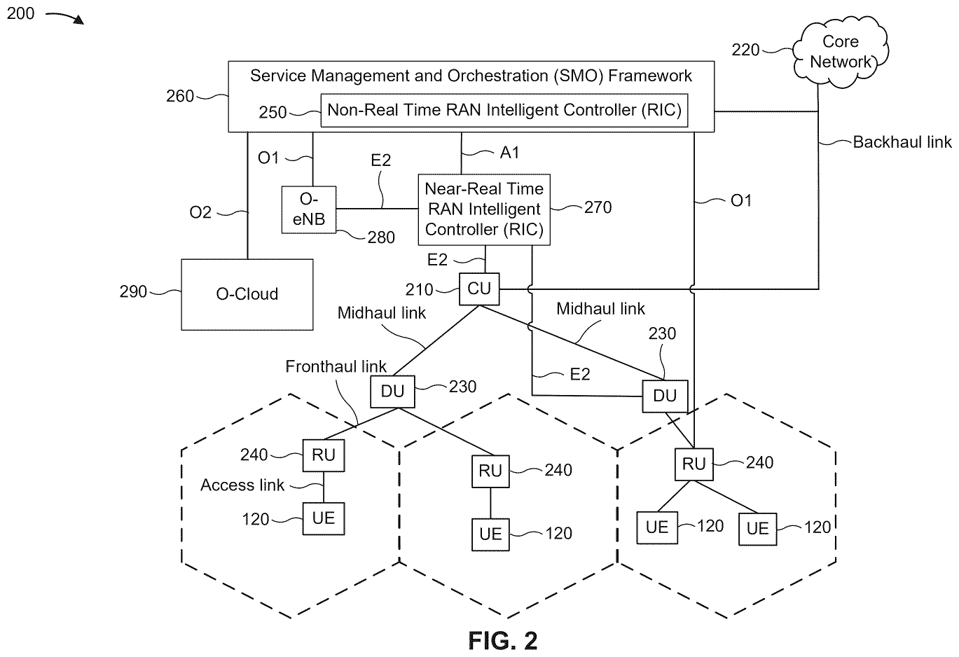

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, one or more network nodes 110, one or more UEs 120, and/or one or more servers, and/or one or more components of a cloud computing network, among other examples). For example, in an deployment where AI/ML functionality is performed independently at a device 165, sometimes referred to as “overlay AI/ML”, the AI/ML model (or an instance or portion of the AI/ML model) may be deployed at a UE 120 (for example, at the processing system 140), a network node 110 (for example, at the processing system 145), one or more servers, and/or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML and/or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, and/or efficient use of network bandwidth, and/or to reduce latency, among other examples). For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 120, device selection criteria (for example, according to a geographical area where measurements are to be collected and/or UE capabilities to be used to collected measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples).

Various aspects of wireless communication network 100 may relate generally to energy efficient full duplex operations. Some aspects of wireless communication network 100 more specifically relate to the UE 120 and/or the network node 110 applying one or more SBFD message handling rules if one or more wireless messages are scheduled during SBFD symbols that coincide with the cell DRX inactive period and/or the cell DTX inactive period. In some aspects, the network node 110 may transmit configuration information to the UE 120 that indicates a single configuration that aligns a cell DRX mode and the cell DTX mode in time. For example, the single configuration may indicate a DXX mode, that includes a DXX inactive period where the network node 110 refrains from both wireless transmission and wireless reception. In some aspects, if a wireless message is scheduled during SBFD symbols that coincide with the DXX inactive period, the one or more SBFD message handling rules may indicate for the UE 120 and/or network node 110 to drop the wireless message based on a message type (e.g., drop semi-statically configured messages and communicate dynamically configured messages or messages that include positioning information). In some aspects, the network node 110 may transmit configuration information to the UE 120 that indicates separate configurations for the cell DRX mode and the cell DTX mode. If, a wireless message is scheduled during SBFD symbols that coincide with the DRX inactive period or a DTX inactive period, then the one or more SBFD message handling rules may indicate one or more cell DRX rules, one or more cell DTX rules, and/or one or more collision handling rules. Therefore, the UE 120 may operate in accordance with the one or more SBFD message handling rules to mitigate potential collisions between uplink and downlink messages that overlap at the UE 120 and/or to determine which message types may be communicated during SBFD symbols that coincide with the DRX inactive period or a DTX inactive period. In some examples, the network node 110 may transmit, and the UE 120 may receive configuration information that indicates one or more SBFD message handling rules. In some examples, the UE 120 may be preconfigured with the one or more SBFD message handling rules.

Particular aspects of the subject matter described in this disclosure can be implemented to realize one or more of the following potential advantages. In some examples, the described techniques can be used to increase communication reliability between the network node 110 and the UE 120. For example, the one or more SBFD message handling rules may enable the UE 120 to determine which messages may be allowed for communication and which messages may be dropped during SBFD symbols that coincide with the DRX inactive period, the DTX inactive period, and/or the DXX inactive period. Therefore, the one or more SBFD message handling rules may enable UE 120 behavior to efficiently drop and/or communicate wireless messages, which may increase message reliability and/or reduce message latency, while maintaining energy savings (at the UE 120 and the network node 110) associated with operating in accordance with the cell DRX/DTX/DXX modes.

In some aspects, the UE 120 may include a communication manager 150. As described in more detail elsewhere herein, the communication manager 150 may receive, from a network node, information that indicates that a cell of the network node is operating in accordance with a subband full duplex (SBFD) mode; receive, from the network node, configuration information that indicates a DRX mode associated with the cell and a discontinuous transmission (DTX) mode associated with the cell; receive, from the network node, control information that schedules transmission of at least one message during an SBFD time interval in accordance with the SBFD mode, wherein the SBFD time interval at least partially overlaps in time with one or more of a DRX inactive period associated with the DRX mode or a DTX inactive period associated with the DTX mode; and communicate, with the network node, the at least one message in accordance with one or more SBFD message handling rules based at least in part on the SBFD time interval at least partially overlapping in time with one or more of the DRX inactive period or the DTX inactive period, wherein the one or more SBFD message handling rules are associated with the SBFD mode and one or more of the DRX mode or the DTX mode. Additionally, or alternatively, the communication manager 150 may perform one or more other operations described herein.

In some aspects, the network node 110 may include a communication manager 155. As described in more detail elsewhere herein, the communication manager 155 may transmit, to a UE, information that indicates that a cell of the network node is operating in accordance with an SBFD mode; transmit, to the UE, configuration information that indicates a DRX mode associated with the cell and a discontinuous transmission (DTX) mode associated with the cell; transmit, to the UE, control information that schedules transmission of at least one message during an SBFD time interval in accordance with the SBFD mode, wherein the SBFD time interval at least partially overlaps in time with one or more of a DRX inactive period associated with the DRX mode or a DTX inactive period associated with the DTX mode; and communicate, with the UE, the at least one message in accordance with one or more SBFD message handling rules based at least in part on the SBFD time interval at least partially overlapping in time with one or more of the DRX inactive period or the DTX inactive period, wherein the one or more SBFD message handling rules are associated with the SBFD mode and one or more of the DRX mode or the DTX mode. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

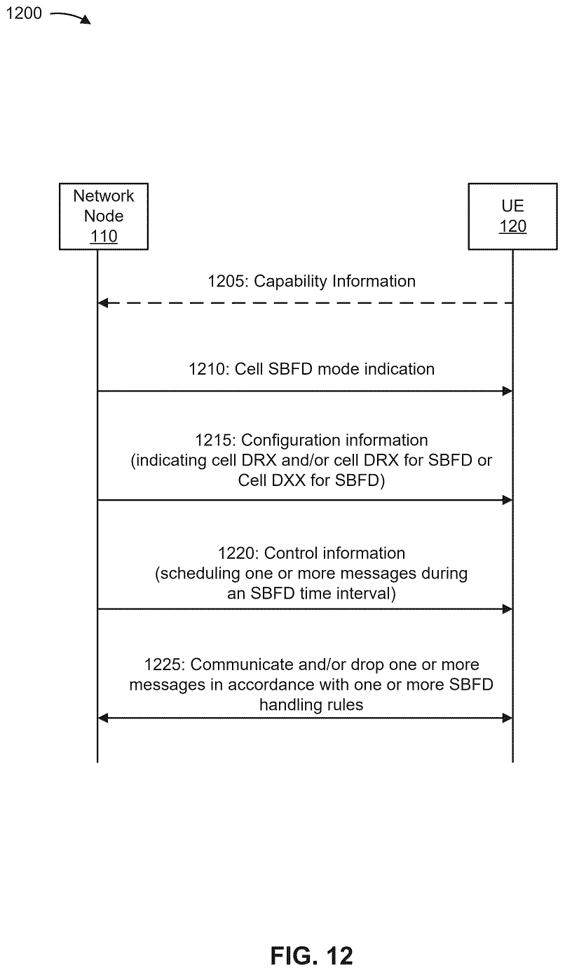

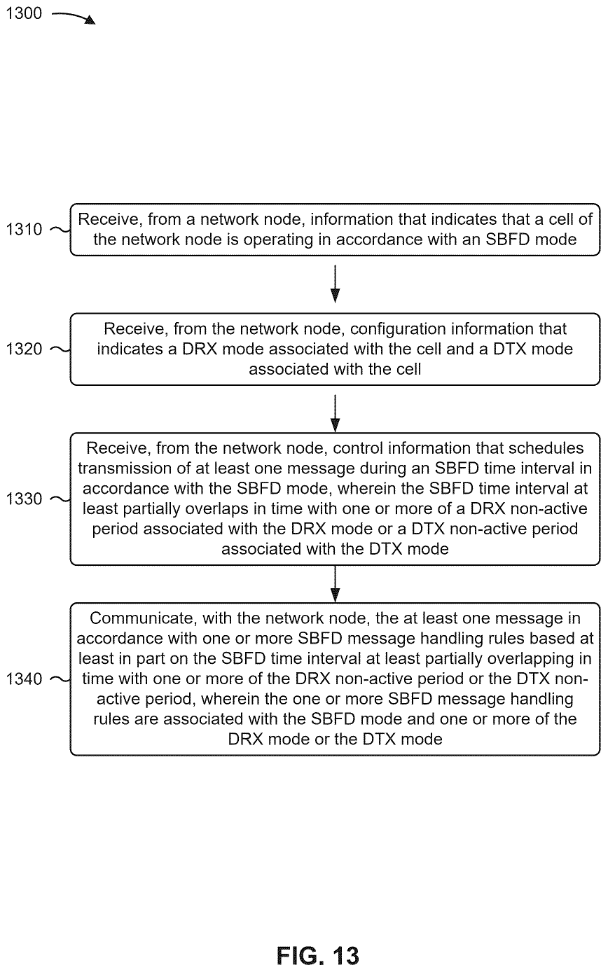

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with energy efficient full duplex operations, as described in more detail elsewhere herein. For example, the processing system 145 of the network node 110, the processing system 140 of the UE 120, the CU 210, the DU 230, or the RU 240 may perform or direct operations of, for example, process 1200 of FIG. 12, process 1300 of FIG. 13, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 1200 of FIG. 12, process 1300 of FIG. 13, or other processes as described herein. In some examples, executing instructions may include running the instructions, converting the instructions, compiling the instructions, and/or interpreting the instructions, among other examples.

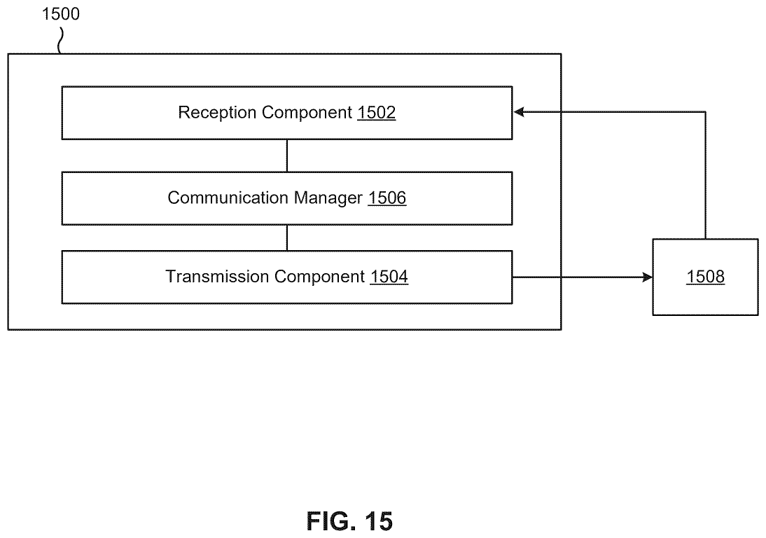

In some aspects, a UE includes means for receiving, from a network node, information that indicates that a cell of the network node is operating in accordance with an SBFD mode; means for receiving, from the network node, configuration information that indicates a DRX mode associated with the cell and a discontinuous transmission (DTX) mode associated with the cell; means for receiving, from the network node, control information that schedules transmission of at least one message during an SBFD time interval in accordance with the SBFD mode, wherein the SBFD time interval at least partially overlaps in time with one or more of a DRX inactive period associated with the DRX mode or a DTX inactive period associated with the DTX mode; and/or means for communicating, with the network node, the at least one message in accordance with one or more SBFD message handling rules based at least in part on the SBFD time interval at least partially overlapping in time with one or more of the DRX inactive period or the DTX inactive period, wherein the one or more SBFD message handling rules are associated with the SBFD mode and one or more of the DRX mode or the DTX mode. The means for the UE to perform operations described herein may include, for example, one or more of communication manager 150, processing system 140, a radio, one or more RF chains, one or more transceivers, one or more antennas, one or more modems, a reception component (for example, reception component 1502 depicted and described in connection with FIG. 15), and/or a transmission component (for example, transmission component 15-4 depicted and described in connection with FIG. 15), among other examples.

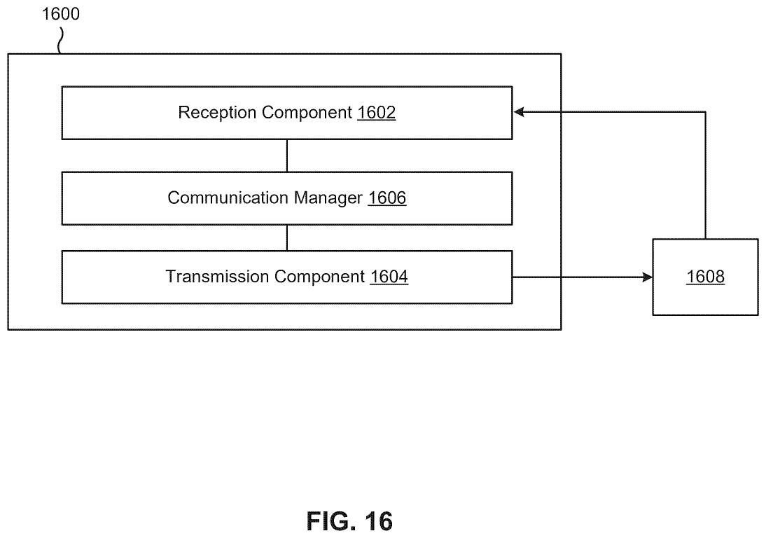

In some aspects, a network node includes means for transmitting, to a UE, information that indicates that a cell of the network node is operating in accordance with an SBFD mode; means for transmitting, to the UE, configuration information that indicates a DRX mode associated with the cell and a discontinuous transmission (DTX) mode associated with the cell; means for transmitting, to the UE, control information that schedules transmission of at least one message during an SBFD time interval in accordance with the SBFD mode, wherein the SBFD time interval at least partially overlaps in time with one or more of a DRX inactive period associated with the DRX mode or a DTX inactive period associated with the DTX mode; and/or means for communicating, with the UE, the at least one message in accordance with one or more SBFD message handling rules based at least in part on the SBFD time interval at least partially overlapping in time with one or more of the DRX inactive period or the DTX inactive period, wherein the one or more SBFD message handling rules are associated with the SBFD mode and one or more of the DRX mode or the DTX mode. The means for the network node to perform operations described herein may include, for example, one or more of communication manager 155, processing system 145, a radio, one or more RF chains, one or more transceivers, one or more antennas, one or more modems, a reception component (for example, reception component 1602 depicted and described in connection with FIG. 16), and/or a transmission component (for example, transmission component 1604 depicted and described in connection with FIG. 16), among other examples.

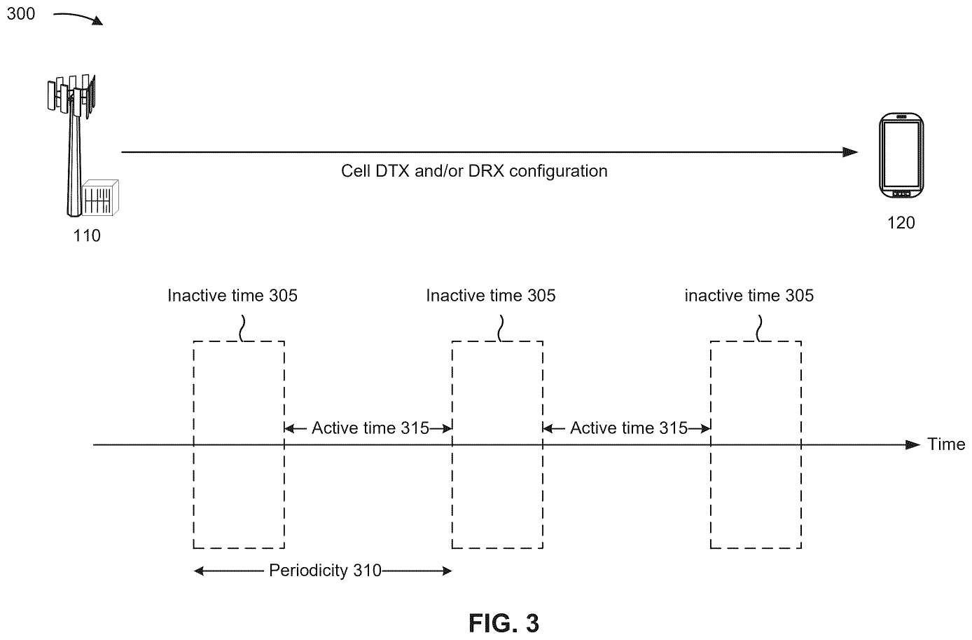

FIG. 3 is a diagram illustrating an example 300 of cell DTX and/or DRX, in accordance with the present disclosure. As shown in FIG. 3, example 300 includes a UE 120 in communication with a network node 110. In some examples, the UE 120 may be in a connected state (e.g., an RRC connected state) with the network node 110.

As shown, the network node 110 may transmit and/or activate a cell DTX and/or DRX configuration to the UE 120 to configure a cell DTX and/or DRX cycle for the UE 120. For example, the configuration may be for cell DTX, cell DRX, or both cell DTX and cell DRX. The configuration may indicate an inactive time 305 (which may also be referred to as an “uplink and/or downlink channel restriction window”) for the cycle. The configuration may indicate a starting time of the inactive time 305 (e.g., a time offset), a duration of the inactive time 305, and/or a periodicity 310 of the inactive time 305, among other examples. One or more types of physical channels or signals may be restricted during the inactive time 305 (e.g., a restricted channel or signal that is scheduled or configured during the inactive time 305 may be dropped by the network node 110 and/or the UE 120). That is, the UE 120 may be expected to not transmit or receive particular channels or signals during the inactive time 305. In this way, the network node 110 may enter a sleep state during the inactive time 305. Downlink channels or signals restricted during the inactive time 305 may include periodic and/or semi-persistent CSI-RSs (e.g., including TRSs), PRSs, PDCCHs scrambled with a UE-specific radio network temporary identifier (RNTI), PDCCHs in a type-3 common search space (CSS) (e.g., a group-common PDCCH), and/or semi-persistent scheduling (SPS) PDSCHs, among other examples. Additionally, or alternatively, uplink channels or signals restricted during the inactive time 305 may include scheduling requests, periodic and/or semi-persistent CSI reports, periodic and/or semi-persistent SRSs, and/or CG PUSCHs, among other examples. As further shown, cell DTX and/or DRX may include active times 315 outside of (e.g., between) inactive times 305. Physical channel or signal restrictions applicable to the inactive time 305 may not be applicable to the active time 315.

In some examples, during the inactive time 305, the UE 120 may be expected to drop physical channels or signals associated with a minimal impact to UE implementation complexity or system performance. For example, in downlink, the UE 120 may drop reception of a PDCCH in a type-3 CSS, an SPS communication, a CSI-RS for generating CSI, and/or a CSI-RS for propagation delay compensation, among other examples. Additionally, or alternatively, in uplink, the UE 120 may drop transmission of a scheduling request, a CG communication, and/or CSI feedback, among other examples. However, during the inactive time 305, the UE 120 may not be expected to drop physical channels or signals associated with a high impact to UE implementation complexity or system performance. For example, in downlink, the UE 120 may receive a CSI-RS for tracking (e.g., a TRS), a CSI-RS for positioning, a CSI-RS for beam management, and/or a CSI-RS for beam failure detection, among other examples. Additionally, or alternatively, in uplink, the UE 120 may transmit an SRS for positioning and/or a scheduling request, among other examples.

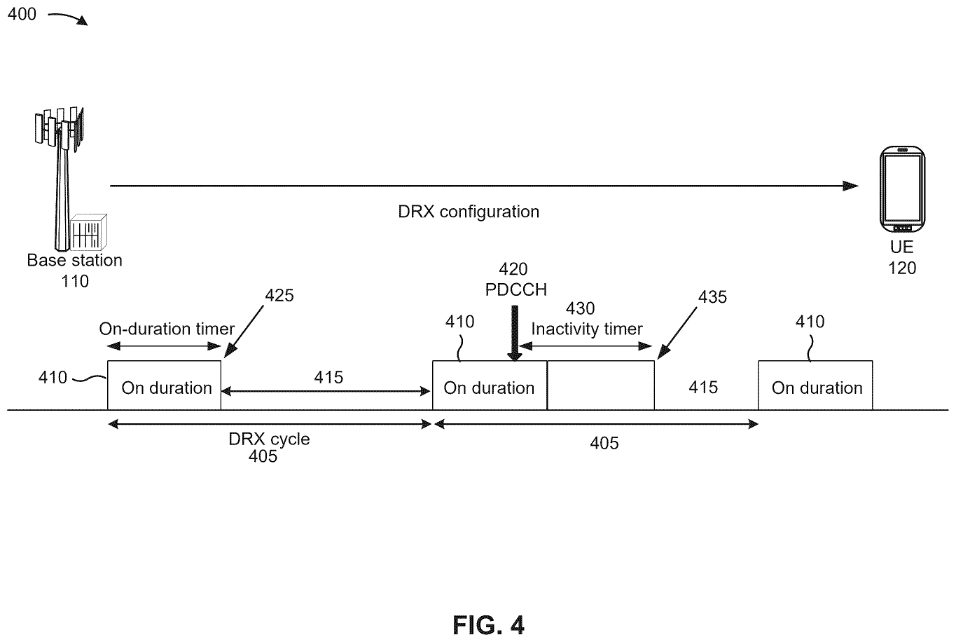

FIG. 4 is a diagram illustrating an example 400 of a DRX configuration, in accordance with the present disclosure.

As shown in FIG. 4, a network node 110 may transmit a DRX configuration to a UE 120 to configure a DRX cycle 405 for the UE 120. A DRX cycle 405 may include a DRX on duration 410 (e.g., during which a UE 120 is awake or in an active state) and an opportunity to enter a DRX sleep state 415. As used herein, the time during which the UE 120 is configured to be in an active state during the DRX on duration 410 may be referred to as an active time, and the time during which the UE 120 is configured to be in the DRX sleep state 415 may be referred to as an inactive time. As described below, the UE 120 may monitor a PDCCH during the active time, and may refrain from monitoring the PDCCH during the inactive time.

During the DRX on duration 410 (e.g., the active time), the UE 120 may monitor a downlink control channel (e.g., a PDCCH), as shown by reference number 420. For example, the UE 120 may monitor the PDCCH for DCI pertaining to the UE 120. If the UE 120 does not detect and/or successfully decode any PDCCH communications intended for the UE 120 during the DRX on duration 410, then the UE 120 may enter the sleep state 415 (e.g., for the inactive time) at the end of the DRX on duration 410, as shown by reference number 425. In this way, the UE 120 may conserve battery power and reduce power consumption. As shown, the DRX cycle 405 may repeat with a configured periodicity according to the DRX configuration.

If the UE 120 detects and/or successfully decodes a PDCCH communication intended for the UE 120, then the UE 120 may remain in an active state (e.g., awake) for the duration of a DRX inactivity timer 430 (e.g., which may extend the active time). The UE 120 may start the DRX inactivity timer 430 at a time at which the PDCCH communication is received (e.g., in a transmission time interval (TTI) in which the PDCCH communication is received, such as a slot or a subframe). The UE 120 may remain in the active state until the DRX inactivity timer 430 expires, at which time the UE 120 may enter the sleep state 415 (e.g., for the inactive time), as shown by reference number 435. During the duration of the DRX inactivity timer 430, the UE 120 may continue to monitor for PDCCH communications, may obtain a downlink data communication (e.g., on a downlink data channel, such as a physical downlink shared channel (PDSCH)) scheduled by the PDCCH communication, and/or may prepare and/or transmit an uplink communication (e.g., on a physical uplink shared channel (PUSCH)) scheduled by the PDCCH communication. The UE 120 may restart the DRX inactivity timer 430 after each detection of a PDCCH communication for the UE 120 for an initial transmission (e.g., but not for a retransmission). By operating in this manner, the UE 120 may conserve battery power and reduce power consumption by entering the sleep state 415.

As indicated above, FIG. 4 is provided as an example. Other examples may differ from what is described with respect to FIG. 4.

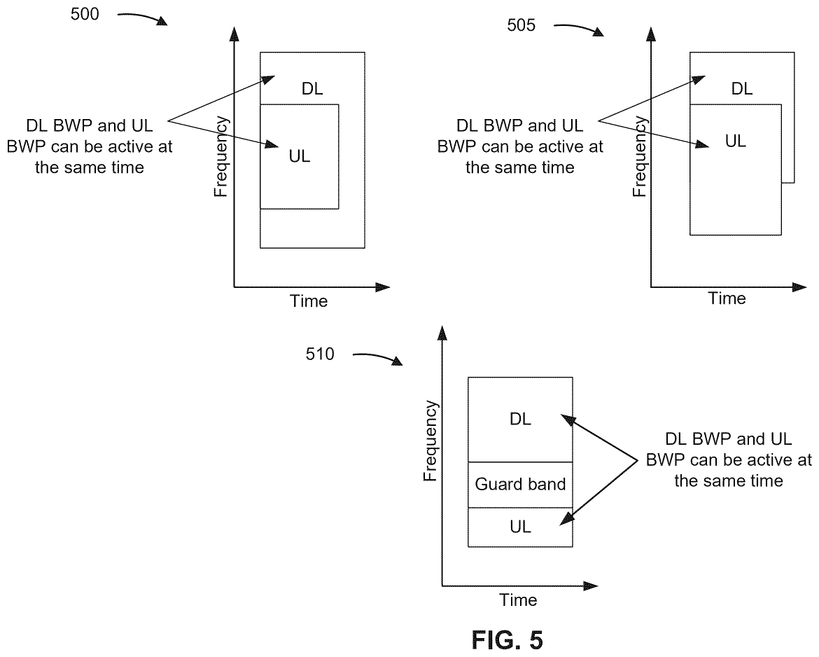

FIG. 5 is a diagram illustrating examples 500, 505, and 510 of full-duplex communication in a wireless network, in accordance with the present disclosure. “Full-duplex communication” in a wireless network refers to simultaneous bi-directional communication between devices in the wireless network. For example, a UE operating in a full-duplex mode may transmit an uplink communication and receive a downlink communication at the same time (e.g., in the same slot or the same symbol). “Half-duplex communication” in a wireless network refers to unidirectional communications (e.g., only downlink communication or only uplink communication) between devices at a given time (e.g., in a given slot or a given symbol).

As shown in FIG. 5, examples 500 and 505 show examples of in-band full-duplex (IBFD) communication. In IBFD, a UE may transmit an uplink communication to a base station and receive a downlink communication from the base station on the same time and frequency resources. As shown in example 500, in a first example of IBFD, the time and frequency resources for uplink communication may fully overlap with the time and frequency resources for downlink communication. As shown in example 505, in a second example of IBFD, the time and frequency resources for uplink communication may partially overlap with the time and frequency resources for downlink communication.

As further shown in FIG. 5, example 510 shows an example of subband full-duplex (SBFD) communication, which may also be referred to as “subband frequency division duplex (SBFDD)” or “flexible duplex.” In SBFD, a UE may transmit an uplink communication to a base station and receive a downlink communication from the base station at the same time, but on different frequency resources. For example, the different frequency resources may be subbands of a frequency band, such as a time division duplexing band. In this case, the frequency resources used for downlink communication may be separated from the frequency resources used for uplink communication, in the frequency domain, by a guard band.

As indicated above, FIG. 5 is provided as an example. Other examples may differ from what is described with respect to FIG. 5.

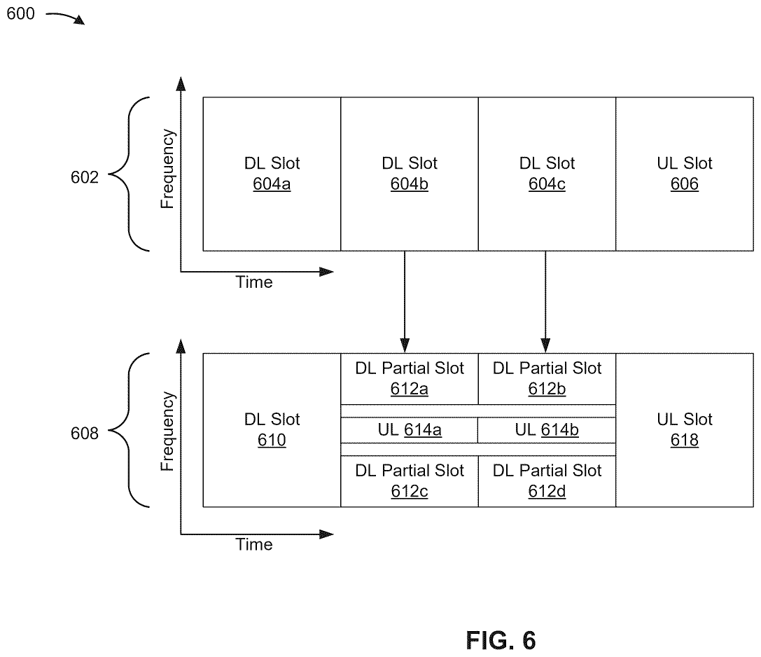

FIG. 6 is a diagram illustrating an example 600 of SBFD activation, in accordance with the present disclosure. As shown in FIG. 6, example 600 includes a first configuration 602. In some aspects, the first configuration 602 may indicate a first slot format pattern (sometimes called a time division duplexing (TDD) pattern) associated with a half-duplex mode or a full-duplex mode. The first slot format pattern may include a quantity of downlink slots (e.g., three downlink slots 604a, 604b, and 604c, as shown), a quantity of flexible slots (not shown), and/or a quantity of uplink slots (e.g., one uplink slot 606, as shown). The first slot format pattern may repeat over time. In some aspects, a network node 110 may indicate the first slot format pattern to a UE 120 using one or more slot format indicators. A slot format indicator, for a slot, may indicate whether that slot is an uplink slot, a downlink slot, or a flexible slot, among other examples.

A network node 110 may instruct (e.g., using an indication, such as a radio resource control (RRC) message, a medium access control (MAC) control element (CE) (MAC-CE), or DCI) a UE 120 to switch from the first configuration 602 to a second configuration 608. As an alternative, the UE 120 may indicate to the network node 110 that the UE 120 is switching from the first configuration 602 to the second configuration 608. The second configuration 608 may indicate a second slot format pattern that repeats over time, similar to the first slot format pattern. In any of the aspects described above, the UE 120 may switch from the first configuration 602 to the second configuration 608 during a time period (e.g., a quantity of symbols and/or an amount of time (e.g., in ms)) based at least in part on an indication received from the network node 110 (e.g., before switching back to the first configuration 602). During that time period, the UE 120 may communicate using the second slot format pattern, and then may revert to using the first slot format pattern after the end of the time period. The time period may be indicated by the network node 110 (e.g., in the instruction to switch from the first configuration 602 to the second configuration 608, as described above) and/or based at least in part on a programmed and/or otherwise preconfigured rule. For example, the rule may be based at least in part on a table (e.g., defined in 3GPP specifications and/or another wireless communication standard) that associates different sub-carrier spacings (SCSs) and/or numerologies (e.g., represented by μ and associated with corresponding SCSs) with corresponding time periods for switching configurations.

In example 600, the second slot format pattern includes two SBFD slots in place of what were downlink slots in the first slot format pattern. In example 600, each SBFD slot includes a partial slot (e.g., a portion or subband of a frequency allocated for use by the network node 110 and the UE 120) for downlink (e.g., partial slots 612a, 612b, 612c, and 612d, as shown) and a partial slot for uplink (e.g., partial slots 614a and 614b, as shown). Accordingly, the UE 120 may operate using the second slot format pattern to transmit an uplink communication in an earlier slot (e.g., the second slot in sequence, shown as partial uplink (UL) slot 614a) as compared to using the first slot format pattern (e.g., the fourth slot in sequence, shown as UL slot 618). Other examples may include additional or alternative changes. For example, the second configuration 608 may include downlink (DL) slot 610 and UL slot 618 may indicate an SBFD slot in

place of what was an uplink slot in the first configuration 602 (e.g., UL slot 606). In another example, the second configuration 608 may indicate a downlink slot or an uplink slot in place of what was an SBFD slot in the first configuration 602 (not shown in FIG. 6). In yet another example, the second configuration 608 may indicate a downlink slot or an uplink slot in place of what was an uplink slot or a downlink slot, respectively, in the first configuration 602. An “SBFD slot” may refer to a slot in which an SBFD format is used. An SBFD format may include a slot format in which full duplex communication is supported (e.g., for both uplink and downlink communications), with one or more frequencies used for an uplink portion of the slot being separated from one or more frequencies used for a downlink portion of the slot by a guard band. In some aspects, the SBFD format may include a single uplink portion and a single downlink portion separated by a guard band. In some aspects, the SBFD format may include multiple downlink portions and a single uplink portion that is separated from the multiple downlink portions by respective guard bands (e.g., as shown in FIG. 6). In some aspects, an SBFD format may include multiple uplink portions and a single downlink portion that is separated from the multiple uplink portions by respective guard bands. In some aspects, the SBFD format may include multiple uplink portions and multiple downlink portions, where each uplink portion is separated from a downlink portion by a guard band. In some aspects, operating using an SBFD mode may include activating or using an a full duplex mode in one or more slots based at least in part on the one or more slots having the SBFD format. A slot may support the SBFD mode if an UL BWP and a DL BWP are permitted to be or are simultaneously active in the slot in an SBFD fashion (e.g., with guard band separation).

By switching from the first configuration 602 to the second configuration 608, the network node 110 and the UE 120 may experience increased quality and/or reliability of communications. For example, the network node 110 and the UE 120 may experience increased throughput (e.g., using a full-duplex mode), reduced latency (e.g., the UE 120 may be able to transmit an uplink and/or a downlink communication sooner using the second configuration 608 rather than the first configuration 602), and increased network resource utilization (e.g., by using both the DL BWP and the UL BWP simultaneously instead of only the DL BWP or the UL BWP).

As indicated above, FIG. 6 is provided as an example. Other examples may differ from what is described with respect to FIG. 6.

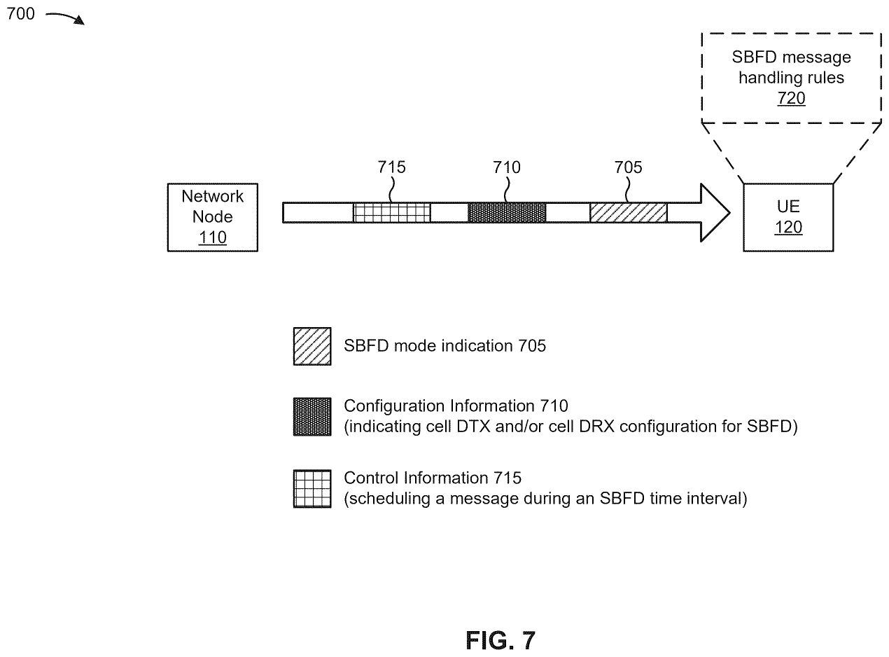

FIG. 7 is a diagram illustrating an example 700 associated with configuring energy efficient full duplex operations, in accordance with the present disclosure. Example 700 may implement or be implemented by one or more aspects of FIGS. 1 through 6. For instance, example 700 may include wireless communications between the network node 110 and the UE 120. Additionally, example 700 may operate in accordance with one or more aspects of full duplex/SBFD configurations as described with reference to FIGS. 5 and 6.

As shown in FIG. 7, the network node 110 may transmit, and the UE 120 may receive, an SBFD mode indication 705. For example, the SBFD mode indication 705 may indicate that a cell of the network node 110 is operating in accordance with one or more SBFD time intervals that include one or more uplink subbands (such as one or more partial slots 614) and include one or more downlink subbands (such as one or more partial slots 612).

The SBFD mode indication 705 may include slot configuration information that indicates which time intervals within a frame are configured for SBFD operation (e.g., specific uplink and downlink symbols within each SBFD slot). The SBFD mode indication 705 may include a cell configuration that indicates whether the cell supports SBFD across all frequencies or specific frequency carriers and/or frequency bands that the cell supports SBFD operations for. The SBFD mode indication 705 may include a channel configuration that configures specific physical channels (e.g., PUCCH, PUSCH, PDCCH, and PDSCH) for SBFD operation. The SBFD mode indication 705 may indicate a subcarrier spacing (e.g., indicate the subcarrier spacing and BWP configuration for SBFD operation) and/or a duplex mode (e.g., indicate whether the cell operates in SBFD, half duplex (HD), or a mix of both). The SBFD mode indication 705 may indicate power control parameters and/or interference cancellation instructions to manage interference caused by concurrent uplink and downlink transmissions. The SBFD mode indication 705 may indicate HARQ processes for uplink and downlink transmissions that may overlap in SBFD slots. The SBFD mode indication 705 may indicate how uplink and downlink resources are scheduled within SBFD slots (for example, indicate resource block assignments and timing information). The SBFD mode indication 705 may indicate timing advance information (e.g., update the timing advance configuration to ensure that uplink transmissions align with the SBFD slot structure).

In some examples, the SBFD mode indication 705 may be indicated across one or more control signals. For example, the SBFD mode indication 705 may be indicated via one or more of system information (e.g., including master information block (MIB) and/or SIB transmissions), RRC signaling (e.g., including an RRC Connection Setup message and/or an RRC Connection Reconfiguration message), MAC signaling (e.g., including one or more MAC-CEs), or DCI. In some examples, the network node 110 may dynamically update one or more parameters associated with the SBFD mode of the cell (e.g., via a MAC-CE to indicate changes to the SBFD configuration).

As shown in FIG. 7, the network node 110 may transmit, and the UE 120 may receive, configuration information 710. In some examples, the configuration information 710 indicates a cell DTX mode and/or a cell DRX mode of the cell in the SBFD mode. For example, for an SBFD-capable network node 110, the configuration information 710 may indicate a cell DTX configuration and a cell DRX configuration that are independent. In other words, the cell DTX mode and the cell DRX mode may be configured with separate configuration parameters (such as respective active times and inactive times, as described elsewhere herein). In some other examples, the configuration information 710 may indicate a single configuration for the cell DTX mode and the cell DRX mode. For instance, the single configuration may be a cell DXX mode, where the active times of DTX and DRX operations of the cell are aligned in time and the inactive times of DTX and DRX operations of the cell are aligned in time.

In some examples, the configuration information 710 may be indicated via one or more control signals. For example, the configuration information 710 may be indicated via one or more of system information (e.g., including MIB and/or SIB transmissions), RRC signaling (e.g., including an RRC Connection Setup message and/or an RRC Connection Reconfiguration message), MAC signaling (e.g., including one or more MAC-CEs), or DCI. In some examples, the configuration information 710 or separate control signaling may activate (e.g., enable) the cell DTX mode, the cell DRX mode, and/or the cell DXX mode. For example, the cell DTX mode, the cell DRX mode, and/or the cell DXX mode may be configured and/or activated via RRC signaling or a group-common DCI (e.g., a DCI of format 2_9).

As shown in FIG. 7, the network node 110 may transmit, and the UE 120 may receive, control information 715. In some examples, the control information 715 may schedule one or more messages for transmission during an SBFD time interval of the cell. In some examples, the control information 715 may schedule one or more semi-statically configured uplink messages, such as one or more of a scheduling request (SR) message, a configured grant (CG) PUSCH, a periodic SRS message, or a semi-persistent SRS message. Additionally, or alternatively, the control information 715 may schedule a dynamically configured uplink message, such as a dynamic grant (DG) uplink message. Additionally, or alternatively, the control information 715 may schedule one or more semi-statically configured downlink messages, such as one or more of an SPS-PDSCH message, a user-specific space (USS) PDCCH message, a group common PDCCH (e.gg., with DCI format 2_X, where X=0, 1, . . . , 5), a periodic CSI-RS, or a semi-persistent CSI-RS. Additionally, or alternatively, the control information 715 may schedule a dynamically configured downlink message, such as a DG downlink message.

As described herein, semi-static configuration of uplink and downlink messages are set by the network node 110 via higher layer signaling (such as RRC signaling). Semi-static configurations are particularly suited for periodic transmissions or operations that occur consistently over time. Therefore, the control information 715 may semi-statically assign resources for PDSCH/PDCCH reception and/or PUSCH/PUCCH transmission for periodic data transfer. Conversely, a dynamic configuration of uplink and downlink messages may include a configuration or scheduling of resources that are determined on-the-fly by the network node 110. In accordance with a dynamic configuration, the control information 715 allocates resources or configures parameters for the message, via lower layer signaling (e.g., MAC layer signaling and/or DCI). Therefore, the control information 715 may dynamically assign resources for PDSCH/PDCCH reception and/or PUSCH/PUCCH transmission in real-time.

In some examples, the one or more messages (scheduled for transmission during the SBFD time interval) may be additionally scheduled during an inactive time associated with the cell DTX mode, the cell DRX mode, and/or the cell DXX mode. Therefore, the UE 120 may operate in accordance with one or more SBFD message handling rules 720 to determine whether to drop or communicate the one or more messages.

If a message is scheduled for transmission during one or more SBFD symbols and at least partially overlaps in time with an inactive time period of the cell DXX mode, the one or more SBFD message handling rules 720 may indicate to drop or communicate the message based on the type of message. For example, the UE 120 may drop a message if the message is an SPS downlink message, a USS PDCCH message, a PDCCH message associated with group-common DCI, a periodic CSI-RS or a semi-persistent CSI-RS, a configured grant uplink message, an uplink scheduling request message, an SRS not associated with positioning information, or a CSI report. Additionally, the UE 120 may communicate the message if the message is a DG downlink message, a DG uplink message, or an SRS message that indicates positioning information. Therefore, the SBFD message handling rules 720 associated with the inactive time of the cell DXX mode may enable the UE 120 to drop one or more messages during SBFD symbols, which may increase energy savings at the network node 110 and the UE 120. Additionally, the SBFD message handling rules 720 associated with the inactive time of the cell DXX mode may consider higher priority message types (such as DG uplink/downlink messages and positioning information), which may enable the UE 120 and network node 110 to communicate latency sensitive messages during the inactive time of the cell DXX mode.

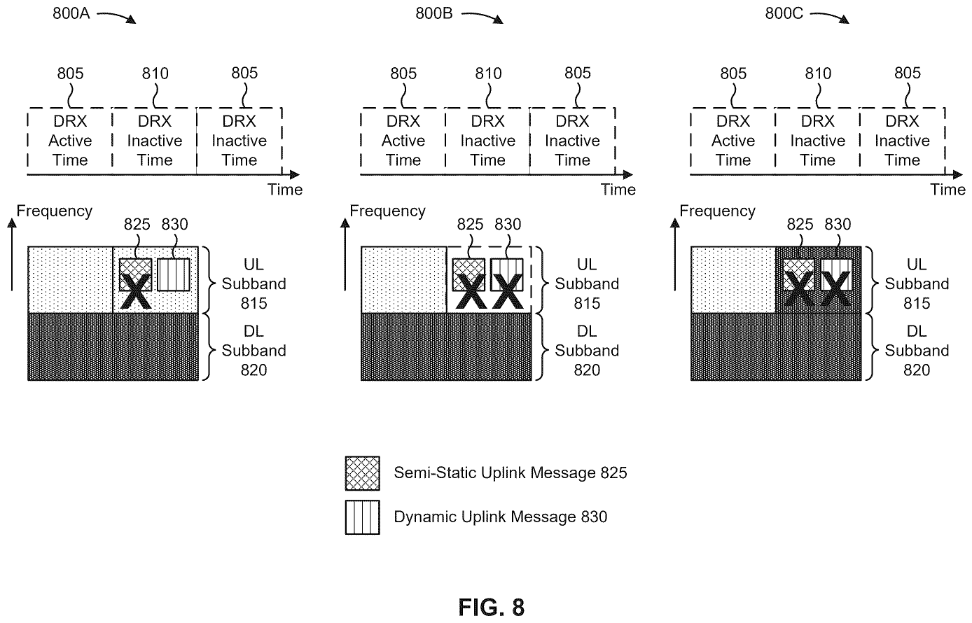

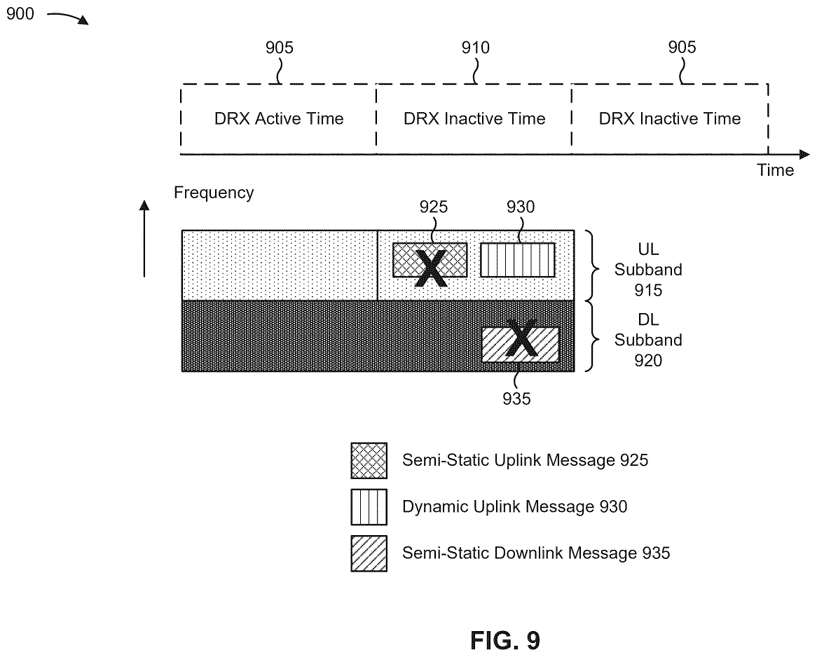

If a message is scheduled for transmission during one or more SBFD symbols and at least partially overlaps in time with an inactive time period of the cell DRX mode, the one or more SBFD message handling rules 720 may indicate whether to drop or communicate the message in accordance with one or more collision handling rules and one or more cell DRX rules, as described elsewhere herein (e.g., with reference to FIGS. 8 and 9).

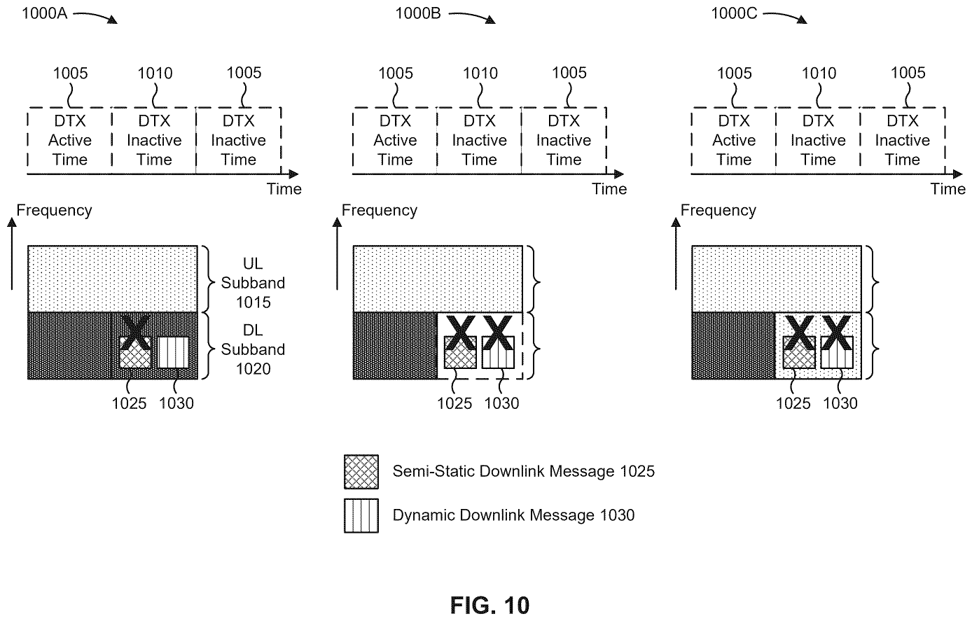

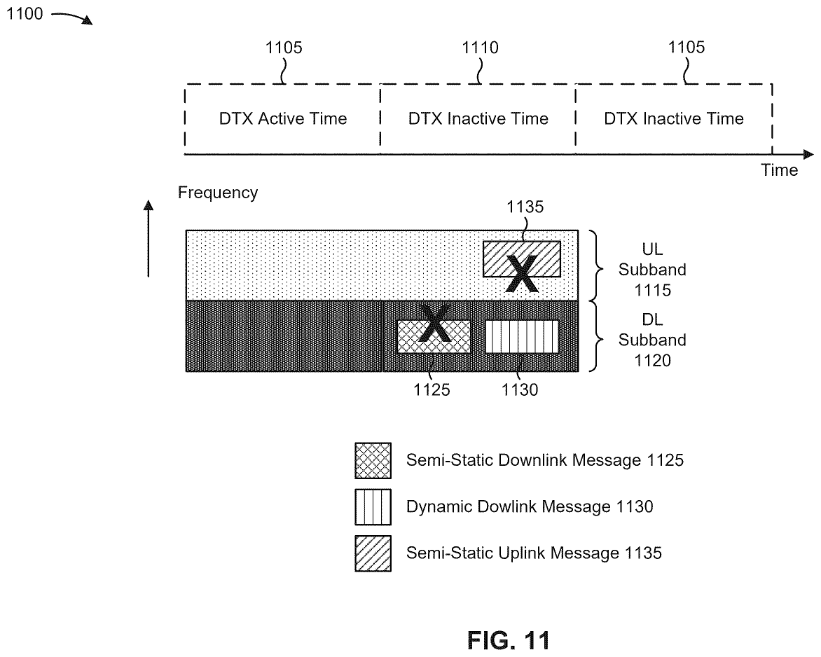

If a message is scheduled for transmission during one or more SBFD symbols and at least partially overlaps in time with an inactive time period of the cell DTX mode, the one or more SBFD message handling rules 720 may indicate whether to drop or communicate the message in accordance with one or more collision handling rules and one or more cell DTX rules, as described elsewhere herein (e.g., with reference to FIGS. 10 and 11).

FIG. 8 is a diagram illustrating examples 800A, 800B, and 800C associated with dropping or communicating messages associated with full duplex resources and a DRX inactive time, in accordance with the present disclosure. Example 800 may implement or be implemented by one or more aspects of FIGS. 1 through 7. For instance, example 800 may include the UE 120 operating in accordance with the one or more SBFD message handling rules 720 to determine whether to drop or communicate one or more messages.

As shown in examples 800A through 800C, the UE 120 may be operating in accordance with an SBFD mode of a cell of the network node 110. For example, the network node 110 may configure one or more SBFD time intervals associated with one or more uplink subbands 815 that include uplink time/frequency resources and one or more downlink subbands 820 that include downlink time/frequency resources. In some examples, one or more operations and/or parameters of the SBFD mode, as shown in examples 800A through 800C, may be configured via an SBFD mode indication (e.g., SBFD mode indication 705).

As shown in examples 800A through 800C, the UE 120 may be operating in accordance with a cell DRX mode of the cell of the network node 110. For example, the cell DRX mode may be associated with a DRX active time 805 and a DRX inactive time 810. In some examples, the DRX inactive time 810 may implement one or more aspects of inactive time 305, as described with reference to FIG. 3. For example, the DRX inactive time 810 may be associated with a starting time (e.g., a time offset), a duration of the DRX inactive time 810, and/or a periodicity of the DRX inactive time 810. One or more types of physical channels or signals may be restricted during the DRX inactive time 810 (e.g., a restricted channel or signal that is scheduled or configured during the DRX inactive time 810 may be dropped by the network node 110 and/or the UE 120). For example, during the DRX inactive time 810, the network node 110 may refrain from receiving one or more uplink messages from the UE 120 (e.g., sent via PUCCH or PUSCH). Additionally, the DRX active time 805 may implement one or more aspects of active time 315, as described with reference to FIG. 3. For example, DRX active times 805 may be outside of (e.g., between) DRX inactive times 810. Physical channel or signal restrictions applicable to the DRX inactive times 810 may not be applicable to the DRX active times 805. In other words, the UE 120 may transmit one or more uplink messages during the DRX active time 805. In some examples, the cell DRX mode may be configured and/or activated via the configuration information 710 or other control signaling. For example, for an SBFD-capable network node 110, the cell DRX mode may be configured or activated via RRC signaling and/or a group-common DCI of format 2-9.

As shown in FIG. 8, the UE 120 may be scheduled with one or more uplink messages in the uplink subband 815 of the SBFD time interval. For example, the UE 120 may be scheduled with a semi-static uplink message 825. The semi-static uplink message 825 may be an example of an uplink SR message, a CG-PUSCH, a periodic SRS message, a semi-persistent SRS message, or any other semi-statically configured uplink message described elsewhere herein. Additionally, the UE 120 may be scheduled with a dynamic uplink message 830. For example, the dynamic uplink message 830 may be an example of an uplink message scheduled for transmission via DG signaling. Additionally, as shown in FIG. 8, the semi-static uplink message 825 and the dynamic uplink message 830 are both scheduled for transmission during the DRX inactive time 810. Accordingly, examples 800A, 800B, and 800C respectively illustrate the UE 120 implementing various SBFD message handling rules 720 to determine whether to communicate or drop one or more of the scheduled uplink messages.

In accordance with example 800A, the UE 120 may operate in accordance with a first DRX cell rule (e.g., included in the one or more SBFD message handling rules 720). In some examples, the first DRX cell rule may indicate for the UE 120 to drop semi-statically configured uplink messages that are scheduled during SBFD resources and that at least partially overlap with the DRX inactive time 810. Additionally, the first DRX cell rule may indicate for the UE 120 to transmit dynamically configured uplink messages that are scheduled during SBFD resources and that at least partially overlap with the DRX inactive time 810 (e.g., uplink transmission by DG is allowed). Therefore, by operating in accordance with the first DRX rule, the UE 120 may drop the semi-static uplink message 825 and transmit the dynamic uplink message 830. By operating in accordance with example 800A, the network node 110 may balance energy savings of the network node 110 and the UE 120 by dropping semi-static uplink messages while still transmitting dynamic uplink messages, which may include latency sensitive data.

In accordance with example 800B, the UE 120 may operate in accordance with a second DRX cell rule (e.g., included in the one or more SBFD message handling rules 720). In some examples, the second DRX cell rule may indicate for the UE 120 to drop all uplink messages that are scheduled at least partially during SBFD resources and that at least partially overlap with the DRX inactive time 810. In other words, the UE 120 may still treat SBFD symbols during the DRX inactive time 810 as SBFD symbols; however, the UE 120 may only perform downlink reception within the downlink subband 820 (e.g., no uplink transmissions in the uplink subband 815, and no downlink reception outside of the downlink subband 820). Therefore, by operating in accordance with the second DRX rule, the UE 120 may drop both the semi-static uplink message 825 and the dynamic uplink message 830. By operating in accordance with example 800B, the network node 110 may prioritize energy savings of the network node 110 and the UE 120 over uplink transmissions, which may reduce power expenditure at both the network node 110 and the UE 120.

In accordance with example 800C, the UE 120 may operate in accordance with a third DRX cell rule (e.g., included in the one or more SBFD message handling rules 720). In some examples, the third DRX cell rule may indicate for the UE 120 to drop all uplink messages that are scheduled at least partially during SBFD resources and that at least partially overlap with the DRX inactive time 810. Additionally, the third DRX cell rule may indicate for the UE 120 to reconfigure the resources of the uplink subband 815 as downlink resources for reception of downlink messages. In other words, the UE 120 may assume that SBFD symbols during the DRX inactive time 810 are downlink symbols (e.g., only for downlink reception within the whole downlink BWP, which is associated with a fallback from SBFD to full downlink). Therefore, by operating in accordance with the third DRX rule, the UE 120 may drop both the semi-static uplink message 825 and the dynamic uplink message 830 and may monitor/receive downlink messages across both the downlink subband 820 and the uplink subband 815. By operating in accordance with example 800C, the network node 110 may prioritize energy savings of the network node 110 and the UE 120 over uplink transmissions, which may reduce power expenditure at both the network node 110 and the UE 120. Additionally, example 800C may enable reutilization of uplink resources that would otherwise go unused as downlink resources, which may increase resource utilization.

FIG. 9 is a diagram illustrating example 900 associated with conflict resolution of uplink and downlink messages associated with full duplex resources and a DRX inactive time, in accordance with the present disclosure. Example 900 may implement or be implemented by one or more aspects of FIGS. 1 through 8. For instance, example 900 may include the UE 120 operating in accordance with the one or more SBFD message handling rules 720 to determine whether to drop or communicate one or more messages. Additionally, DRX active time 905 may be an example of DRX active time 805, DRX inactive time 910 may be an example of DRX inactive time 810, uplink subband 915 may be an example of uplink subband 815, downlink subband 920 may be an example of downlink subband 820, semi-static uplink message 925 may be an example of semi-static uplink message 825, and dynamic uplink message 930 may be an example of dynamic uplink message 830, as described with reference to FIG. 8.

As shown in example 900, the UE 120 may be further scheduled with a semi-static downlink message 935. The semi-static downlink message 935 may be an example of an SPS-PDSCH message, a USS PDCCH message, a group common PDCCH (e.gg., with DCI format 2_X, where X=0, 1, . . . , 5), a periodic CSI-RS, a semi-persistent CSI-RS, or any other semi-statically configured downlink message described elsewhere herein. Additionally, in example 900, the semi-static downlink message 935 may at least partially overlap in time with one or more of the semi-static uplink message 925 or the dynamic uplink message 930. In other words, there may be a conflict between one or more uplink transmissions in the uplink subband 915 and downlink reception in the downlink subband 920.

For an SBFD-capable network node 110, when cell DRX is configured or activated via RRC signaling or group-common DCI format 2-9 and the DRX inactive time 910 overlaps with one or more SBFD symbols, and there is a conflict between one or more uplink transmissions in the uplink subband 915 and downlink reception in the downlink subband 920, then the UE 120 may operate in accordance with one or more collision handling rules and one or more cell DRX rules (e.g., the cell DRX rules as described with reference to FIG. 8).

In some examples, the one or more collision handling rules may be associated with one or more techniques of collision handling resolution in SBFD symbols as defined in a wireless communications standard (such as 3GPP). In a first case, if a semi-statically configured uplink message overlaps in time with a dynamically configured downlink message, then the one or more collision handling rules may indicate for the UE 120 to cancel (e.g., drop) the semi-statically configured uplink message within a configured cancellation timeline. In a second case, if a semi-statically configured downlink message overlaps in time with a dynamically configured uplink message, then the one or more collision handling rules may indicate for the UE 120 to cancel (e.g., drop) the semi-statically configured downlink message within a configured cancellation timeline. In a third case, if a dynamically configured downlink message overlaps in time with a dynamically configured uplink message, then the one or more collision handling rules may indicate an error case (e.g., the third case is unexpected). In a fourth case, if a semi-statically configured downlink message overlaps in time with a semi-statically configured uplink message, then the one or more collision handling rules may indicate an error case (e.g., the fourth case is unexpected). In a fifth case, the one or more one or more collision handling rules may indicate for the UE 120 to allow SSBs located in the downlink subband 920 but to drop SSBs located in the uplink subband 915 (e.g., no uplink transmissions in symbols associated with SSB).

As described herein, the UE 120 may apply both the one or more collision handling rules and the one or more cell DRX rules, as described in example 800.

In a first example, the UE 120 may apply the one or more cell DRX rules before applying the one or more collision handling rules. For instance, example 800 may be associated with the first cell DRX rule. Therefore, the UE 120 may first drop the semi-static uplink message 925 and allow the dynamic uplink message 930. Then, after applying the first cell DRX rule, the UE 120 may drop the semi-static downlink message 935 and transmit dynamic uplink message 930 in accordance with the second case of the one or more collision handling rules.

In a second example, the UE 120 may apply the one or more collision handling rules before applying the one or more cell DRX rules. For instance, the UE 120 may first drop the semi-static downlink message 935 and allow the dynamic uplink message 930 in accordance with the second case of the one or more collision handling rules. Then, after applying the one or more collision handling rules, the UE 120 may apply the one or more cell DRX rules. For instance, as described herein, example 900 is associated with the first cell DRX rule, such that the UE 120 may drop the semi-static uplink message 925 and transmit the dynamic uplink message 930.

While example 900 illustrates the UE 120 applying the first cell DRX rule and the second case of the one or more collision handling rules, other examples of the herein-described techniques of message collision handling may apply any of the one or more cell DRX rules and any of the cases of the one or more collision handling rules.

FIG. 10 is a diagram illustrating examples 1000A, 1000B, and 1000C associated with dropping or communicating messages associated with full duplex resources and a DTX inactive time, in accordance with the present disclosure. Example 1000 may implement or be implemented by one or more aspects of FIGS. 1 through 7. For instance, example 1000 may include the UE 120 operating in accordance with the one or more SBFD message handling rules 720 to determine whether to drop or communicate one or more messages.

As shown in examples 1000A through 1000C, the UE 120 may be operating in accordance with an SBFD mode of a cell of the network node 110. For example, the network node 110 may configure one or more SBFD time intervals associated with one or more uplink subbands 1015 that include downlink time/frequency resources and one or more downlink subbands 1020 that include downlink time/frequency resources. In some examples, one or more operations and/or parameters of the SBFD mode, as shown in examples 1000A through 1000C, may be configured via an SBFD mode indication (e.g., SBFD mode indication 705).

As shown in examples 1000A through 1000C, the UE 120 may be operating in accordance with a cell DTX mode of the cell of the network node 110. For example, the cell DTX mode may be associated with a DTX active time 1005 and a DTX inactive time 1010. In some examples, the DTX inactive time 1010 may implement one or more aspects of inactive time 305, as described with reference to FIG. 3. For example, the DTX inactive time 1010 may be associated with a starting time (e.g., a time offset), a duration of the DTX inactive time 1010, and/or a periodicity of the DTX inactive time 1010. One or more types of physical channels or signals may be restricted during the DTX inactive time 1010 (e.g., a restricted channel or signal that is scheduled or configured during the DTX inactive time 1010 may be dropped by the network node 110 and/or the UE 120). For example, during the DTX inactive time 1010, the network node 110 may refrain from transmitting one or more downlink messages to the UE 120 (e.g., sent via PDCCH or PDSCH). Additionally, the DTX active time 1005 may implement one or more aspects of active time 315, as described with reference to FIG. 3. For example, DTX active times 1005 may be outside of (e.g., between) DTX inactive times 1010. Physical downlink channel or signal restrictions applicable to the DTX inactive times 1010 may not be applicable to the DTX active times 1005. In other words, the UE 120 may receive one or more downlink messages during the DTX active time 1005. In some examples, the cell DTX mode may be configured and/or activated via the configuration information 710 or other control signaling. For example, for an SBFD-capable network node 110, the cell DTX mode may be configured or activated via RRC signaling and/or a group-common DCI of format 2-9.

As shown in FIG. 10, the UE 120 may be scheduled with one or more downlink messages in the downlink subband 1020 of the SBFD time interval. For example, the UE 120 may be scheduled with a semi-static downlink message 1025. The semi-static downlink message 1025 may be an example of an SPS-PDSCH message, a USS PDCCH message, a group common PDCCH (e.g., with DCI format 2_X, where X=0,1, . . . , 5), a periodic CSI-RS, a semi-persistent CSI-RS, or any other semi-statically configured downlink message described elsewhere herein. Additionally, the UE 120 may be scheduled with a dynamic downlink message 1030. For example, the dynamic downlink message 1030 may be an example of a downlink message scheduled for transmission via DG signaling. Additionally, as shown in FIG. 10, the semi-static downlink message 1025 and the dynamic downlink message 1030 are both scheduled for transmission by the network node during the DTX inactive time 1010. Accordingly, example 1000A, 1000B, and 1000C respectively illustrate the UE 120 implementing various SBFD message handling rules 720 to determine whether to communicate or drop one or more of the scheduled downlink messages.

In accordance with example 1000A, the UE 120 may operate in accordance with a first DTX cell rule (e.g., included in the one or more SBFD message handling rules 720). In some examples, the first DTX cell rule may indicate for the UE 120 to drop semi-statically configured downlink messages that are scheduled during SBFD resources and that at least partially overlap with the DTX inactive time 1010. Additionally, the first DTX cell rule may indicate for the UE 120 to receive dynamically configured downlink messages that are scheduled during SBFD resources and that at least partially overlap with the DTX inactive time 1010 (e.g., downlink reception by DG is allowed). Therefore, by operating in accordance with the first DTX rule, the UE 120 may drop the semi-static downlink message 1025 and receive the dynamic downlink message 1030. By operating in accordance with example 1000A, the network node 110 may balance energy savings of the network node 110 and the UE 120 by dropping semi-static downlink messages while still communicating dynamic downlink messages, which may include latency sensitive data.

In accordance with example 1000B, the UE 120 may operate in accordance with a second DTX cell rule (e.g., included in the one or more SBFD message handling rules 720). In some examples, the second DTX cell rule may indicate for the UE 120 to drop all downlink messages that are scheduled during SBFD resources and that at least partially overlap with the DTX inactive time 1010. In other words, the UE 120 may still treat SBFD symbols during the DTX inactive time 1010 as SBFD symbols; however, the UE 120 may only perform uplink transmission within the uplink subband 1015 (e.g., no downlink reception in the uplink subband 1015, and no downlink reception outside of the downlink subband 1020). Therefore, by operating in accordance with the second DTX rule, the UE 120 may drop both the semi-static downlink message 1025 and the dynamic downlink message 1030. By operating in accordance with example 1000B, the network node 110 may prioritize energy savings of the network node 110 and the UE 120 over downlink transmissions, which may reduce power expenditure at both the network node 110 and the UE 120.

In accordance with example 1000C, the UE 120 may operate in accordance with a third DTX cell rule (e.g., included in the one or more SBFD message handling rules 720). In some examples, the third DTX cell rule may indicate for the UE 120 to drop all downlink messages that are scheduled during SBFD resources and that at least partially overlap with the DTX inactive time 1010. Additionally, the third DTX cell rule may indicate for the UE 120 to reconfigure the resources of the downlink subband 1020 as uplink resources for transmission of uplink messages. In other words, the UE 120 may assume that SBFD symbols during the DTX inactive time 1010 are uplink symbols (e.g., only for uplink transmission within the whole uplink BWP, which is associated with a fallback from SBFD to full uplink). Therefore, by operating in accordance with the third DTX rule, the UE 120 may drop both the semi-static downlink message 1025 and the dynamic downlink message 1030 and may transmit uplink messages across both the downlink subband 1020 and the uplink subband 1015. By operating in accordance with example 1000C, the network node 110 may prioritize energy savings of the network node 110 and the UE 120 over downlink transmissions, which may reduce power expenditure at both the network node 110 and the UE 120. Additionally, example 1000C may enable reutilization of downlink resources (that would otherwise go unused) as uplink resources, which may increase resource utilization.

FIG. 11 is a diagram illustrating example 1100 associated with conflict resolution of uplink and downlink messages associated with full duplex resources and a DTX inactive time, in accordance with the present disclosure. Example 1100 may implement or be implemented by one or more aspects of FIGS. 1-7 and 10. For instance, example 1100 may include the UE 120 operating in accordance with the one or more SBFD message handling rules 720 to determine whether to drop or communicate one or more messages. Additionally, DTX active time 1105 may be an example of DTX active time 1005, DTX inactive time 1110 may be an example of DTX inactive time 1010, uplink subband 1115 may be an example of uplink subband 1015, downlink subband 1120 may be an example of downlink subband 1020, semi-static downlink message 1125 may be an example of semi-static downlink message 1025, and dynamic downlink message 1130 may be an example of dynamic downlink message 1030, as described with reference to FIG. 10.

As shown in example 1100, the UE 120 may be further scheduled with a semi-static uplink message 1135. The semi-static uplink message 1135 may be an example of an uplink SR message, a CG-PUSCH, a periodic SRS message, a semi-persistent SRS message, or any other semi-statically configured uplink message described elsewhere herein. Additionally, in example 1100, the semi-static uplink message 1135 may at least partially overlap in time with one or more of the semi-static downlink message 1125 or the dynamic downlink message 1130. In other words, there may be a conflict between an uplink transmission in the uplink subband 1115 and one or more downlink receptions in the downlink subband 1120.

For an SBFD-capable network node 110, when cell DTX is configured or activated via RRC signaling or group-common DCI format 2-9 and the DTX inactive time 1110 overlaps with one or more SBFD symbols, and there is a conflict between an uplink transmission in the uplink subband 1115 and one or more downlink receptions in the downlink subband 1120, then the UE 120 may operate in accordance with one or more collision handling rules and one or more cell DTX rules (e.g., the cell DTX rules as described with reference to FIG. 10).

In some examples, the one or more collision handling rules may be associated with one or more techniques of collision handling resolution in SBFD symbols as defined in a wireless communications standard (such as 3GPP). In a first case, if a semi-statically configured uplink message overlaps in time with a dynamically configured downlink message, then the one or more collision handling rules may indicate for the UE 120 to cancel (e.g., drop) the semi-statically configured uplink message within a configured cancellation timeline. In a second case, if a semi-statically configured downlink message overlaps in time with a dynamically configured uplink message, then the one or more collision handling rules may indicate for the UE 120 to cancel (e.g., drop) the semi-statically configured downlink message within a configured cancellation timeline. In a third case, if a dynamically configured downlink message overlaps in time with a dynamically configured uplink message, then the one or more collision handling rules may indicate an error case (e.g., the third case is unexpected). In a fourth case, if a semi-statically configured downlink message overlaps in time with a semi-statically configured uplink message, then the one or more collision handling rules may indicate an error case (e.g., the fourth case is unexpected). In a fifth case, the one or more one or more collision handling rules may indicate for the UE 120 to allow SSBs located in the downlink subband 1120 but to drop SSBs located in the uplink subband 1115 (e.g., no uplink transmissions in symbols associated with SSB).

As described herein, the UE 120 may apply both the one or more collision handling rules and the one or more cell DTX rules, as described in example 1100.

In a first example, the UE 120 may apply the one or more cell DTX rules before applying the one or more collision handling rules. For instance, example 1100 may be associated with the first cell DTX rule. Therefore, the UE 120 may first drop the semi-static downlink message 1125 and allow the dynamic downlink message 1130. Then, after applying the first cell DTX rule, the UE 120 may drop the semi-static uplink message 1135 and receive the dynamic downlink message 1130 in accordance with the first case of the one or more collision handling rules.

In a second example, the UE 120 may apply the one or more collision handling rules before applying the one or more cell DTX rules. For instance, the UE 120 may first drop the semi-static uplink message 1135 and allow the dynamic downlink message 1130 in accordance with the first case of the one or more collision handling rules. Then, after applying the one or more collision handling rules, the UE 120 may apply the one or more cell DTX rules. For instance, as described herein, example 1100 is associated with the first cell DTX rule, such that the UE 120 may drop the semi-static downlink message 1125 and receive the dynamic downlink message 1130.

While example 1100 illustrates the UE 120 applying the first cell DTX rule and the first case of the one or more collision handling rules, the techniques of message collision handling described herein may apply any of the one or more cell DTX rules and any of the cases of the one or more collision handling rules.

FIG. 12 is a diagram illustrating an example 1200 associated with energy efficient full duplex operations, in accordance with the present disclosure. Example 1200 may implement or be implemented by one or more aspects of FIGS. 1-11. For instance, example 1200 includes wireless communications between the UE 120 and the network node 110. Alternative examples of the following may be implemented, where some operations are performed in a different order than described, or not described at all. In some cases, one or more operations may include additional features not mentioned below, or further operations may be added. In addition, while example 1200 shows operations between the UE 120 and the network node 110, the communication may occur between any number of network devices of various types described herein.

Additionally, the UE 120 and network node 110 may operate in accordance with one or more respective components to perform the operations of example 1200. For example, with reference to example 1220, the UE 120 may perform one or more transmission operations using the transmission component 1504 of FIG. 15, may perform one or more reception operations using the reception component 1502 of FIG. 15, and/or may perform one or more drop operations using communication manager 150 or 1506. Further, with reference to example 1200, the network node 110 may perform one or more transmission operations using the transmission component 1604 of FIG. 16, may perform one or more reception operations using the reception component 1602 of FIG. 16 and/or may perform one or more drop operations using communication manager 155 or 1606.

In some aspects, as shown by first operation 1205, the UE 120 may optionally transmit, and the network node 110 may receive, capability information. The capability information may be included in a capability report. The UE 120 may transmit the capability information via an uplink communication, a sidelink communication, a unicast communication, a broadcast communication, a UE assistance information (UAI) communication, a UCI communication, a sidelink control information (SCI) communication, a MAC-CE communication, an RRC communication, a PUCCH, a PUSCH, a sidelink channel (e.g., a physical sidelink control channel (PSCCH), and/or a physical sidelink shared channel (PSSCH)), among other examples. The capability information may indicate one or more parameters associated with respective capabilities of the UE 120. The one or more parameters may be indicated via respective information elements (IEs) included in a capability report.

The capability information may indicate whether the UE 120 supports a feature and/or one or more parameters related to the feature. For example, the capability information may indicate a capability and/or parameter for supporting an SBFD mode for one or more cells of the network node 110. In other words, the capability information may indicate that the UE 120 is an SBFD-aware UE. In some examples, the capability information may indicate a capability and/or parameter for supporting one or more of a DRX mode, a DTX mode, or a DXX mode of the one or more cells, as described elsewhere herein. In some examples, the capability information may indicate a capability and/or parameter for supporting one or more SBFD message handling rules (e.g., the one or more SBFD message handling rules 720). In other words, the UE 120 may indicate a capability to determine (e.g., using communication manager 150 and/or communication manager 1506) whether to drop or communicate one or more wireless messages that are scheduled during SBFD symbols and are associated with a DRX mode, a DTX mode, and/or a DXX mode of a cell of the network node 110. One or more operations described herein may be based on capability information. For example, the UE 120 may perform a communication in accordance with the capability information or may receive configuration information that is in accordance with the capability information.

In a second operation 1210, the network node 110 may transmit, and the UE 120 may receive, a cell SBFD mode indication (e.g., SBFD mode indication 705). In some examples, the cell SBFD mode indication may include information that indicates that a cell of the network node 110 is operating in accordance with an SBFD mode, as described elsewhere herein. In some examples, the network node 110 may transmit the cell SBFD mode indication based on the capability information (e.g., based on the UE 120 indicating support for an SBFD mode for one or more cells of the network node 110).

In a third operation 1215, the network node 110 may transmit, and the UE 120 may receive, configuration information (e.g., configuration information 710). In some aspects, the UE 120 may receive the configuration information via one or more of system information signaling (e.g., a MIB and/or a SIB, among other examples), RRC signaling, MAC signaling (e.g., one or more MAC-CEs), and/or DCI, among other examples.

The network node 110 may determine (e.g., using communication manager 155/communication manager 1606) the configuration information for the UE 120 based on the capability information. For example, the network node 110 may determine that the UE 120 is to be configured with one or more of a cell DRX mode, a cell DTX mode, or a cell DXX mode based on the capability information indicating that the UE 120 supports one or more of a DRX mode, a DTX mode, or a DXX mode of the one or more cells. Additionally, the network node 110 may indicate the one or more SBFD message handling rules based on the capability information indicating that the UE 120 supports the one or more SBFD message handling rules. In other examples, the network node 110 may determine the configuration information without, or independent of, the capability information. For example, the network node 110 may determine that the UE 120 supports one or more aspects of the capability information based on a type, category, or other classification of the UE 120.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may indicate a candidate configuration and/or communication parameter from the one or more candidate configurations and/or communication parameters. In some aspects, the subsequent indication may include a dynamic indication, such as one or more MAC-CEs and/or one or more DCI messages, among other examples.

In some examples, the configuration information may not be expressly signaled to the UE 120. For example, in some aspects, the configuration information may at least partially be defined by a wireless communication standard, such as the 3GPP. In such examples, the network node 110 may not explicitly indicate such configuration information to the UE 120. For example, the UE 120 may optionally obtain at least a portion of the configuration information from a configuration stored by the UE 120 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some examples, the configuration information indicates the DXX mode that combines the DRX mode and the DTX mode. For example, the DRX inactive period and the DTX inactive period are included in a DXX inactive period associated with the DXX mode. In some other examples, the configuration information indicates independent configurations for the DRX mode and the DTX mode. That is, the DRX mode may be associated with a DRX active time and DRX inactive time and the DTX mode may be associated with a DTX active time and a DTX inactive time, as described elsewhere herein.

In a fourth operation 1220, the network node 110 may transmit, and the UE 120 may receive, control information (e.g., control information 715). In some examples, the control information may schedule transmission of at least one message during an SBFD time interval in accordance with the SBFD mode. Additionally, the SBFD time interval may at least partially overlap in time with one or more of a DRX inactive period associated with the DRX mode, a DTX inactive period associated with the DTX mode, or a DXX inactive period associated with the DXX mode.

In a fifth operation 1225, the network node 110 and the UE 120 may communicate the at least one message. For example, the UE 120 and/or network node 110 may determine whether to drop or communicate the at least one message in accordance with the one or more SBFD message handling rules based on the SBFD time interval at least partially overlapping in time with one or more of the DRX inactive period, the DTX inactive period, or the DXX inactive period. As described elsewhere herein, the one or more SBFD message handling rules may be associated with the SBFD mode and one or more of the DRX mode, the DTX mode, or the DXX mode.

In some examples of the DXX mode, the UE 120 and/or the network node 110 may drop the at least one message based on the one or more SBFD message handling rules indicating that a message type associated with the at least one message cannot be transmitted during the DXX inactive period that at least partially overlaps with the SBFD time interval. For example, the message type may include one or more of an SPS downlink message, a USS PDCCH message, a PDCCH message associated with group-common DCI, a CSI-RS, a configured grant uplink message, an uplink scheduling request message, an SRS not associated with positioning information, or a CSI report.

In some examples of the DXX mode, the at least one message may be an SRS that indicates positioning information. In such examples, the UE 120 may transmit, and the network node 110 may receive during the inactive DXX period, the at least one message based on the one or more SBFD message handling rules indicating that SRSs that indicate positioning information are allowed for transmission during the DXX inactive period that at least partially overlaps with the SBFD time interval.

In some cases, the one or more SBFD symbols of the SBFD time interval overlap with the DRX inactive period, where the one or more SBFD message handling rules include one or more cell DRX rules and include one or more collision handling rules (as described with reference to FIGS. 8 and 9).

In some examples, the at least one message is semi-statically configured by a higher layer (e.g., via RRC signaling). In such examples, the UE 120 and/or network node 110 may drop the at least one message based on the one or more cell DRX rules indicating that semi-statically configured messages cannot be transmitted during the one or more SBFD symbols that overlap with the DRX inactive period.

In some examples, the at least one message is dynamically scheduled. In such examples, the UE 120 may transmit, and the network node 110 may receive during the DRX inactive period, the at least one message based on the one or more cell DRX rules indicating that dynamically scheduled messages are allowed for transmission during the one or more SBFD symbols that overlap with the DRX inactive period.

In some examples, the at least one message is an uplink message. In such examples, the UE 120 and/or network node 110 may drop the at least one message based on the one or more cell DRX rules indicating that uplink messages cannot be transmitted during the one or more SBFD symbols that overlap with the DRX inactive period.

In some examples, the at least one message is an uplink message scheduled in an uplink subband of the one or more SBFD symbols. In such examples, the UE 120 and/or the network node 110 may drop the at least one message based on the one or more cell DRX rules indicating that uplink messages cannot be transmitted during the one or more SBFD symbols that overlap with the DRX inactive period. Additionally, the one or more cell DRX rules may further indicate to reconfigure the one or more SBFD symbols to one or more downlink symbols based on the one or more SBFD symbols overlapping with the DRX inactive period.

In some examples, the SBFD time interval is scheduled with a set of uplink messages that at least partially overlap in time, where the SBFD time interval is scheduled with a downlink message. In a first example, the UE 120 may drop one or more first uplink messages of the set of uplink messages in accordance with the one or more cell DRX rules, where one or more second uplink messages of the set of uplink messages that are not dropped at least partially overlap in time with the downlink message. Additionally, the UE 120 may determine (after dropping the one or more first uplink messages) whether to drop the one or more second uplink messages or the downlink message in accordance with the one or more collision handling rules. For example, the one or more collision handling rules prioritize transmission of dynamically scheduled messages over transmission of semi-statically scheduled messages. In a second example, the UE 120 may determine whether to drop one or more uplink messages of the set of uplink messages or to drop the downlink message in accordance with the one or more collision handling rules, and determine (after determining whether to drop the one or more uplink messages or the downlink message) whether to drop any additional uplink messages from the set of uplink messages in accordance with the one or more cell DRX rules.

In some cases, the one or more SBFD symbols of the SBFD time interval overlap with the DTX inactive period, and the one or more SBFD message handling rules include one or more cell DTX rules and include one or more collision handling rules (as described with reference to FIGS. 10 and 11).

In some examples, the at least one message is semi-statically configured by a higher layer (e.g., via RRC signaling). In such examples, the UE 120 and/or network node 110 may drop the at least one message based on the one or more cell DTX rules indicating that semi-statically configured messages cannot be transmitted during the one or more SBFD symbols that overlap with the DTX inactive period.

In some examples, the at least one message is dynamically scheduled. In such examples, the network node 110 may transmit, and the UE 120 may receive during the DTX inactive period, the at least one message based on the one or more cell DTX rules indicating that dynamically scheduled messages are allowed for transmission during the one or more SBFD symbols that overlap with the DTX inactive period.

In some examples, the at least one message is a downlink message. In such examples, the UE 120 and/or the network node 110 may drop the at least one message based on the one or more cell DTX rules indicating that downlink messages cannot be transmitted during the one or more SBFD symbols that overlap with the DTX inactive period.

In some examples, the at least one message is a downlink message scheduled in a downlink subband of the one or more SBFD symbols. In such examples, the UE 120 and/or the network node 110 may drop the at least one message based on the one or more cell DTX rules indicating that downlink messages cannot be transmitted during the one or more SBFD symbols that overlap with the DTX inactive period. Additionally, the one or more cell DTX rules may further indicate to reconfigure the one or more SBFD symbols to one or more uplink symbols based on the one or more SBFD symbols overlapping with the DTX inactive period.

In some examples, the SBFD time interval is scheduled with a set of downlink messages that at least partially overlap in time, where the SBFD time interval is scheduled with an uplink message. In a first example, the UE 120 and/or the network node 110 may drop one or more first downlink messages of the set of downlink messages in accordance with the one or more cell DTX rules, where one or more second downlink messages of the set of downlink messages that are not dropped at least partially overlap in time with the uplink message. Additionally, the UE 120 and/or the network node 110 may determine, after dropping the one or more first downlink messages, whether to drop the one or more second downlink messages or the uplink message in accordance with the one or more collision handling rules, where the one or more collision handling rules prioritize transmission of dynamically scheduled messages over transmission of semi-statically scheduled messages. In a second example, the UE 120 and/or the network node 110 may determine whether to drop one or more downlink messages of the set of downlink messages or to drop the uplink message in accordance with the one or more collision handling rules, and the determine (after determining whether to drop the one or more downlink messages or the uplink message) whether to drop any additional downlink messages from the set of downlink messages in accordance with the one or more cell DTX rules.

As indicated above, FIG. 12 is provided as an example. Other examples may differ from what is described with regard to FIG. 12.

FIG. 13 is a diagram illustrating an example process 1300 performed, for example, at a UE or an apparatus of a UE, in accordance with the present disclosure. Example process 1300 is an example where the apparatus or the UE (e.g., UE 120) performs operations associated with energy efficient full duplex operations.

As shown in FIG. 13, in some aspects, process 1300 may include receiving, from a network node, information that indicates that a cell of the network node is operating in accordance with an SBFD mode (block 1310). For example, the UE (e.g., using reception component 1502 and/or communication manager 1506, depicted in FIG. 15) may receive, from a network node, information that indicates that a cell of the network node is operating in accordance with an SBFD mode, as described above.

As further shown in FIG. 13, in some aspects, process 1300 may include receiving, from the network node, configuration information that indicates a DRX mode associated with the cell and a discontinuous transmission (DTX) mode associated with the cell (block 1320). For example, the UE (e.g., using reception component 1502 and/or communication manager 1506, depicted in FIG. 15) may receive, from the network node, configuration information that indicates a DRX mode associated with the cell and a discontinuous transmission (DTX) mode associated with the cell, as described above.

As further shown in FIG. 13, in some aspects, process 1300 may include receiving, from the network node, control information that schedules transmission of at least one message during an SBFD time interval in accordance with the SBFD mode, wherein the SBFD time interval at least partially overlaps in time with one or more of a DRX inactive period associated with the DRX mode or a DTX inactive period associated with the DTX mode (block 1330). For example, the UE (e.g., using reception component 1502 and/or communication manager 1506, depicted in FIG. 15) may receive, from the network node, control information that schedules transmission of at least one message during an SBFD time interval in accordance with the SBFD mode, wherein the SBFD time interval at least partially overlaps in time with one or more of a DRX inactive period associated with the DRX mode or a DTX inactive period associated with the DTX mode, as described above.

As further shown in FIG. 13, in some aspects, process 1300 may include communicating, with the network node, the at least one message in accordance with one or more SBFD message handling rules based at least in part on the SBFD time interval at least partially overlapping in time with one or more of the DRX inactive period or the DTX inactive period, wherein the one or more SBFD message handling rules are associated with the SBFD mode and one or more of the DRX mode or the DTX mode (block 1340). For example, the UE (e.g., using reception component 1502, transmission component 1504, and/or communication manager 1506, depicted in FIG. 15) may communicate, with the network node, the at least one message in accordance with one or more SBFD message handling rules based at least in part on the SBFD time interval at least partially overlapping in time with one or more of the DRX inactive period or the DTX inactive period, wherein the one or more SBFD message handling rules are associated with the SBFD mode and one or more of the DRX mode or the DTX mode, as described above.

Process 1300 may include additional aspects, such as any single aspect or any combination of aspects described below and/or in connection with one or more other processes described elsewhere herein.

In a first aspect, the configuration information indicates a DXX mode that combines the DRX mode and the DTX mode, and the DRX inactive period and the DTX inactive period are included in a DXX inactive period associated with the DXX mode.

In a second aspect, alone or in combination with the first aspect, process 1300 includes dropping the at least one message based at least in part on the one or more SBFD message handling rules indicating that a message type associated with the at least one message cannot be transmitted during the DXX inactive period that at least partially overlaps with the SBFD time interval.

In a third aspect, alone or in combination with one or more of the first and second aspects, the message type includes one or more of an SPS downlink message, a USS PDCCH message, a PDCCH message associated with group-common DCI, a CSI-RS, a configured grant uplink message, an uplink scheduling request message, a SRS not associated with positioning information, or a CSI report.

In a fourth aspect, alone or in combination with one or more of the first through third aspects, the at least one message is an SRS that indicates positioning information, and process 1300 includes transmitting, to the cell of the network node during the inactive DXX period, the at least one message based at least in part on the one or more SBFD message handling rules indicating that SRSs that indicate positioning information are allowed for transmission during the DXX inactive period that at least partially overlaps with the SBFD time interval.

In a fifth aspect, alone or in combination with one or more of the first through fourth aspects, the configuration information indicates independent configurations for the DRX mode and the DTX mode.

In a sixth aspect, alone or in combination with one or more of the first through fifth aspects, one or more SBFD symbols of the SBFD time interval overlap with the DRX inactive period, and the one or more SBFD message handling rules include one or more cell DRX rules and include one or more collision handling rules.

In a seventh aspect, alone or in combination with one or more of the first through sixth aspects, the at least one message is semi-statically configured by a higher layer, and process 1300 includes dropping the at least one message based at least in part on the one or more cell DRX rules indicating that semi-statically configured messages cannot be transmitted during the one or more SBFD symbols that overlap with the DRX inactive period.

In an eighth aspect, alone or in combination with one or more of the first through seventh aspects, the at least one message is dynamically scheduled, and process 1300 includes transmitting, to the cell of the network node during the DRX inactive period, the at least one message based at least in part on the one or more cell DRX rules indicating that dynamically scheduled messages are allowed for transmission during the one or more SBFD symbols that overlap with the DRX inactive period.

In a ninth aspect, alone or in combination with one or more of the first through eighth aspects, the at least one message is an uplink message, and process 1300 includes dropping the at least one message based at least in part on the one or more cell DRX rules indicating that uplink messages cannot be transmitted during the one or more SBFD symbols that overlap with the DRX inactive period.

In a tenth aspect, alone or in combination with one or more of the first through ninth aspects, the at least one message is an uplink message scheduled in an uplink subband of the one or more SBFD symbols, and process 1300 includes dropping the at least one message based at least in part on the one or more cell DRX rules indicating that uplink messages cannot be transmitted during the one or more SBFD symbols that overlap with the DRX inactive period, wherein the one or more cell DRX rules further indicate to reconfigure the one or more SBFD symbols to one or more downlink symbols based at least in part on the one or more SBFD symbols overlapping with the DRX inactive period.

In an eleventh aspect, alone or in combination with one or more of the first through tenth aspects, the SBFD time interval is scheduled with a set of uplink messages that at least partially overlap in time, and the SBFD time interval is scheduled with a downlink message, and process 1300 includes dropping one or more first uplink messages of the set of uplink messages in accordance with the one or more cell DRX rules, wherein one or more second uplink messages of the set of uplink messages that are not dropped at least partially overlaps in time with the downlink message, and determining, after dropping the one or more first uplink messages, whether to drop the one or more second uplink messages or the downlink message in accordance with the one or more collision handling rules, wherein the one or more collision handling rules prioritize transmission of dynamically scheduled messages over transmission of semi-statically scheduled messages.

In a twelfth aspect, alone or in combination with one or more of the first through eleventh aspects, the SBFD time interval is scheduled with a set of uplink messages that at least partially overlap in time, and the SBFD time interval is scheduled with a downlink message, and process 1300 includes determining whether to drop one or more uplink messages of the set of uplink messages or to drop the downlink message in accordance with the one or more collision handling rules, wherein the one or more collision handling rules prioritize transmission of dynamically scheduled messages over transmission of semi-statically scheduled messages, and determining, after determining whether to drop the one or more uplink messages or the downlink message, whether to drop any additional uplink messages from the set of uplink messages in accordance with the one or more cell DRX rules.

In a thirteenth aspect, alone or in combination with one or more of the first through twelfth aspects, one or more SBFD symbols of the SBFD time interval overlap with the DTX inactive period, and the one or more SBFD message handling rules include one or more cell DTX rules and include one or more collision handling rules.

In a fourteenth aspect, alone or in combination with one or more of the first through thirteenth aspects, the at least one message is semi-statically configured by a higher layer, and process 1300 includes dropping the at least one message based at least in part on the one or more cell DTX rules indicating that semi-statically configured messages cannot be transmitted during the one or more SBFD symbols that overlap with the DTX inactive period.

In a fifteenth aspect, alone or in combination with one or more of the first through fourteenth aspects, the at least one message is dynamically scheduled, and process 1300 includes receiving, from the cell of the network node during the DTX inactive period, the at least one message based at least in part on the one or more cell DTX rules indicating that dynamically scheduled messages are allowed for transmission during the one or more SBFD symbols that overlap with the DTX inactive period.

In a sixteenth aspect, alone or in combination with one or more of the first through fifteenth aspects, the at least one message is a downlink message, and process 1300 includes dropping the at least one message based at least in part on the one or more cell DTX rules indicating that downlink messages cannot be transmitted during the one or more SBFD symbols that overlap with the DTX inactive period.

In a seventeenth aspect, alone or in combination with one or more of the first through sixteenth aspects, the at least one message is a downlink message scheduled in a downlink subband of the one or more SBFD symbols, and process 1300 includes dropping the at least one message based at least in part on the one or more cell DTX rules indicating that downlink messages cannot be transmitted during the one or more SBFD symbols that overlap with the DTX inactive period, wherein the one or more cell DTX rules further indicate to reconfigure the one or more SBFD symbols to one or more uplink symbols based at least in part on the one or more SBFD symbols overlapping with the DTX inactive period.

In an eighteenth aspect, alone or in combination with one or more of the first through seventeenth aspects, the SBFD time interval is scheduled with a set of downlink messages that at least partially overlap in time, and SBFD time interval is scheduled with an uplink message, and process 1300 includes dropping one or more first downlink messages of the set of downlink messages in accordance with the one or more cell DTX rules, wherein one or more second downlink messages of the set of downlink messages that are not dropped at least partially overlaps in time with the uplink message, and determining, after dropping the one or more first downlink messages, whether to drop the one or more second downlink messages or the uplink message in accordance with the one or more collision handling rules, wherein the one or more collision handling rules prioritize transmission of dynamically scheduled messages over transmission of semi-statically scheduled messages.

In a nineteenth aspect, alone or in combination with one or more of the first through eighteenth aspects, the SBFD time interval is scheduled with a set of downlink messages that at least partially overlap in time, and SBFD time interval is scheduled with an uplink message, and process 1300 includes determining whether to drop one or more downlink messages of the set of downlink messages or to drop the uplink message in accordance with the one or more collision handling rules, wherein the one or more collision handling rules prioritize transmission of dynamically scheduled messages over transmission of semi-statically scheduled messages, and determining, after determining whether to drop the one or more downlink messages or the uplink message, whether to drop any additional downlink messages from the set of downlink messages in accordance with the one or more cell DTX rules.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

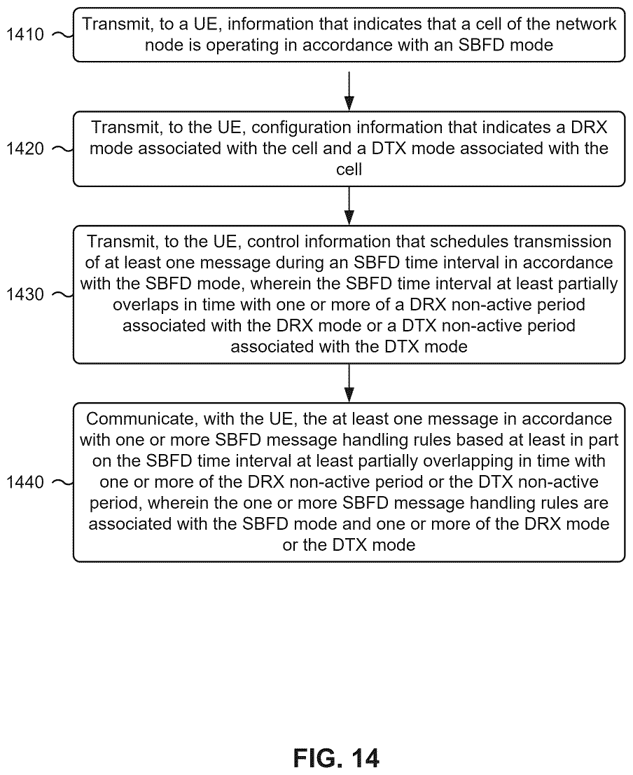

FIG. 14 is a diagram illustrating an example process 1400 performed, for example, at a network node or an apparatus of a network node, in accordance with the present disclosure. Example process 1400 is an example where the apparatus or the network node (e.g., network node 110) performs operations associated with energy efficient full duplex operations.

As shown in FIG. 14, in some aspects, process 1400 may include transmitting, to a UE, information that indicates that a cell of the network node is operating in accordance with an SBFD mode (block 1410). For example, the network node (e.g., using transmission component 1604 and/or communication manager 1606, depicted in FIG. 16) may transmit, to a UE, information that indicates that a cell of the network node is operating in accordance with an SBFD mode, as described above.

As further shown in FIG. 14, in some aspects, process 1400 may include transmitting, to the UE, configuration information that indicates a DRX mode associated with the cell and a discontinuous transmission (DTX) mode associated with the cell (block 1420). For example, the network node (e.g., using transmission component 1604 and/or communication manager 1606, depicted in FIG. 16) may transmit, to the UE, configuration information that indicates a DRX mode associated with the cell and a discontinuous transmission (DTX) mode associated with the cell, as described above.

As further shown in FIG. 14, in some aspects, process 1400 may include transmitting, to the UE, control information that schedules transmission of at least one message during an SBFD time interval in accordance with the SBFD mode, wherein the SBFD time interval at least partially overlaps in time with one or more of a DRX inactive period associated with the DRX mode or a DTX inactive period associated with the DTX mode (block 1430). For example, the network node (e.g., using transmission component 1604 and/or communication manager 1606, depicted in FIG. 16) may transmit, to the UE, control information that schedules transmission of at least one message during an SBFD time interval in accordance with the SBFD mode, wherein the SBFD time interval at least partially overlaps in time with one or more of a DRX inactive period associated with the DRX mode or a DTX inactive period associated with the DTX mode, as described above.

As further shown in FIG. 14, in some aspects, process 1400 may include communicating, with the UE, the at least one message in accordance with one or more SBFD message handling rules based at least in part on the SBFD time interval at least partially overlapping in time with one or more of the DRX inactive period or the DTX inactive period, wherein the one or more SBFD message handling rules are associated with the SBFD mode and one or more of the DRX mode or the DTX mode (block 1440). For example, the network node (e.g., using reception component 1602, transmission component 1604, and/or communication manager 1606, depicted in FIG. 16) may communicate, with the UE, the at least one message in accordance with one or more SBFD message handling rules based at least in part on the SBFD time interval at least partially overlapping in time with one or more of the DRX inactive period or the DTX inactive period, wherein the one or more SBFD message handling rules are associated with the SBFD mode and one or more of the DRX mode or the DTX mode, as described above.

Process 1400 may include additional aspects, such as any single aspect or any combination of aspects described below and/or in connection with one or more other processes described elsewhere herein.

In a first aspect, the configuration information indicates a DXX mode that combines the DRX mode and the DTX mode, and the DRX inactive period and the DTX inactive period are included in a DXX inactive period associated with the DXX mode.

In a second aspect, alone or in combination with the first aspect, process 1400 includes dropping the at least one message based at least in part on the one or more SBFD message handling rules indicating that a message type associated with the at least one message cannot be transmitted during the DXX inactive period that at least partially overlaps with the SBFD time interval.

In a third aspect, alone or in combination with one or more of the first and second aspects, the message type includes one or more of an SPS downlink message, a USS PDCCH message, a PDCCH message associated with group-common DCI, a CSI-RS, a configured grant uplink message, an uplink scheduling request message, a SRS not associated with positioning information, or a CSI report.

In a fourth aspect, alone or in combination with one or more of the first through third aspects, the at least one message is a SRS that indicates positioning information, and process 1400 includes receiving, from the UE via the cell during the inactive DXX period, the at least one message based at least in part on the one or more SBFD message handling rules indicating that SRSs that indicate positioning information are allowed for transmission during the DXX inactive period that at least partially overlaps with the SBFD time interval.

In a fifth aspect, alone or in combination with one or more of the first through fourth aspects, the configuration information indicates independent configurations for the DRX mode and the DTX mode.

In a sixth aspect, alone or in combination with one or more of the first through fifth aspects, one or more SBFD symbols of the SBFD time interval overlap with the DRX inactive period, and the one or more SBFD message handling rules include one or more cell DRX rules and include one or more collision handling rules.

In a seventh aspect, alone or in combination with one or more of the first through sixth aspects, the at least one message is semi-statically configured by a higher layer, and process 1400 includes dropping the at least one message based at least in part on the one or more cell DRX rules indicating that semi-statically configured messages cannot be transmitted during the one or more SBFD symbols that overlap with the DRX inactive period.

In an eighth aspect, alone or in combination with one or more of the first through seventh aspects, the at least one message is dynamically scheduled, and process 1400 includes receiving, from the UE via the cell during the DRX inactive period, the at least one message based at least in part on the one or more cell DRX rules indicating that dynamically scheduled messages are allowed for transmission during the one or more SBFD symbols that overlap with the DRX inactive period.

In a ninth aspect, alone or in combination with one or more of the first through eighth aspects, the at least one message is an uplink message, and process 1400 includes dropping the at least one message based at least in part on the one or more cell DRX rules indicating that uplink messages cannot be transmitted during the one or more SBFD symbols that overlap with the DRX inactive period.

In a tenth aspect, alone or in combination with one or more of the first through ninth aspects, the at least one message is an uplink message scheduled in an uplink subband of the one or more SBFD symbols, and process 1400 includes dropping the at least one message based at least in part on the one or more cell DRX rules indicating that uplink messages cannot be transmitted during the one or more SBFD symbols that overlap with the DRX inactive period, wherein the one or more cell DRX rules further indicate to reconfigure the one or more SBFD symbols to one or more downlink symbols based at least in part on the one or more SBFD symbols overlapping with the DRX inactive period.

In an eleventh aspect, alone or in combination with one or more of the first through tenth aspects, the SBFD time interval is scheduled with a set of uplink messages that at least partially overlap in time, and the SBFD time interval is scheduled with a downlink message, and process 1400 includes dropping one or more first uplink messages of the set of uplink messages in accordance with the one or more cell DRX rules, wherein one or more second uplink messages of the set of uplink messages that are not dropped at least partially overlaps in time with the downlink message, and determining, after dropping the one or more first uplink messages, whether to drop the one or more second uplink messages or the downlink message in accordance with the one or more collision handling rules, wherein the one or more collision handling rules prioritize transmission of dynamically scheduled messages over transmission of semi-statically scheduled messages.

In a twelfth aspect, alone or in combination with one or more of the first through eleventh aspects, the SBFD time interval is scheduled with a set of uplink messages that at least partially overlap in time, and the SBFD time interval is scheduled with a downlink message, and process 1400 includes determining whether to drop one or more uplink messages of the set of uplink messages or to drop the downlink message in accordance with the one or more collision handling rules, wherein the one or more collision handling rules prioritize transmission of dynamically scheduled messages over transmission of semi-statically scheduled messages, and determining, after determining whether to drop the one or more uplink messages or the downlink message, whether to drop any additional uplink messages from the set of uplink messages in accordance with the one or more cell DRX rules.

In a thirteenth aspect, alone or in combination with one or more of the first through twelfth aspects, one or more SBFD symbols of the SBFD time interval overlap with the DTX inactive period, and the one or more SBFD message handling rules include one or more cell DTX rules and include one or more collision handling rules.

In a fourteenth aspect, alone or in combination with one or more of the first through thirteenth aspects, the at least one message is semi-statically configured by a higher layer, and process 1400 includes dropping the at least one message based at least in part on the one or more cell DTX rules indicating that semi-statically configured messages cannot be transmitted during the one or more SBFD symbols that overlap with the DTX inactive period.

In a fifteenth aspect, alone or in combination with one or more of the first through fourteenth aspects, the at least one message is dynamically scheduled, and process 1400 includes transmitting, to the UE during the DTX inactive period, the at least one message based at least in part on the one or more cell DTX rules indicating that dynamically scheduled messages are allowed for transmission during the one or more SBFD symbols that overlap with the DTX inactive period.

In a sixteenth aspect, alone or in combination with one or more of the first through fifteenth aspects, the at least one message is a downlink message, and process 1400 includes dropping the at least one message based at least in part on the one or more cell DTX rules indicating that downlink messages cannot be transmitted during the one or more SBFD symbols that overlap with the DTX inactive period.

In a seventeenth aspect, alone or in combination with one or more of the first through sixteenth aspects, the at least one message is a downlink message scheduled in a downlink subband of the one or more SBFD symbols, and process 1400 includes dropping the at least one message based at least in part on the one or more cell DTX rules indicating that downlink messages cannot be transmitted during the one or more SBFD symbols that overlap with the DTX inactive period, wherein the one or more cell DTX rules further indicate to reconfigure the one or more SBFD symbols to one or more uplink symbols based at least in part on the one or more SBFD symbols overlapping with the DTX inactive period.

In an eighteenth aspect, alone or in combination with one or more of the first through seventeenth aspects, the SBFD time interval is scheduled with a set of downlink messages that at least partially overlap in time, and SBFD time interval is scheduled with an uplink message, and process 1400 includes dropping one or more first downlink messages of the set of downlink messages in accordance with the one or more cell DTX rules, wherein one or more second downlink messages of the set of downlink messages that are not dropped at least partially overlaps in time with the uplink message, and determining, after dropping the one or more first downlink messages, whether to drop the one or more second downlink messages or the uplink message in accordance with the one or more collision handling rules, wherein the one or more collision handling rules prioritize transmission of dynamically scheduled messages over transmission of semi-statically scheduled messages.

In a nineteenth aspect, alone or in combination with one or more of the first through eighteenth aspects, the SBFD time interval is scheduled with a set of downlink messages that at least partially overlap in time, and SBFD time interval is scheduled with an uplink message, and process 1400 includes determining whether to drop one or more downlink messages of the set of downlink messages or to drop the uplink message in accordance with the one or more collision handling rules, wherein the one or more collision handling rules prioritize transmission of dynamically scheduled messages over transmission of semi-statically scheduled messages, and determining, after determining whether to drop the one or more downlink messages or the uplink message, whether to drop any additional downlink messages from the set of downlink messages in accordance with the one or more cell DTX rules.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram of an example apparatus 1500 for wireless communication, in accordance with the present disclosure. The apparatus 1500 may be a UE, or a UE may include the apparatus 1500. In some aspects, the apparatus 1500 includes a reception component 1502, a transmission component 1504, and/or a communication manager 1506, which may be in communication with one another (for example, via one or more buses and/or one or more other components). In some aspects, the communication manager 1506 is the communication manager 150 described in connection with FIG. 1. As shown, the apparatus 1500 may communicate with another apparatus 1508, such as a UE or a network node (such as a CU, a DU, an RU, or a base station), using the reception component 1502 and the transmission component 1504. The communication manager 1506 may be included in, or implemented via, a processing system (for example, the processing system 140 described in connection with FIG. 1) of the UE.

In some aspects, the apparatus 1500 may be configured to perform one or more operations described herein in connection with FIGS. 3 through 12. Additionally, or alternatively, the apparatus 1500 may be configured to perform one or more processes described herein, such as process 1300 of FIG. 13. In some aspects, the apparatus 1500 and/or one or more components shown in FIG. 15 may include one or more components of the UE described in connection with FIG. 1. Additionally, or alternatively, one or more components shown in FIG. 15 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1502 may receive communications, such as reference signals, control information, data communications, or a combination thereof, from the apparatus 1508. The reception component 1502 may provide received communications to one or more other components of the apparatus 1500. In some aspects, the reception component 1502 may perform signal processing on the received communications, and may provide the processed signals to the one or more other components of the apparatus 1500. In some aspects, the reception component 1502 may include one or more components of the UE described above in connection with FIG. 1, such as a radio, one or more RF chains, one or more transceivers, or one or more modems, each of which may in turn be coupled with one or more antennas of the UE.

The transmission component 1504 may transmit communications, such as reference signals, control information, data communications, or a combination thereof, to the apparatus 1508. In some aspects, one or more other components of the apparatus 1500 may generate communications and may provide the generated communications to the transmission component 1504 for transmission to the apparatus 1508. In some aspects, the transmission component 1504 may perform signal processing on the generated communications, and may transmit the processed signals to the apparatus 1508. In some aspects, the transmission component 1504 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1504 may be co-located with the reception component 1502.

The communication manager 1506 may support operations of the reception component 1502 and/or the transmission component 1504. For example, the communication manager 1506 may receive information associated with configuring reception of communications by the reception component 1502 and/or transmission of communications by the transmission component 1504. Additionally, or alternatively, the communication manager 1506 may generate and/or provide control information to the reception component 1502 and/or the transmission component 1504 to control reception and/or transmission of communications.

The reception component 1502 may receive, from a network node, information that indicates that a cell of the network node is operating in accordance with an SBFD mode. The reception component 1502 may receive, from the network node, configuration information that indicates a DRX mode associated with the cell and a DTX mode associated with the cell. The reception component 1502 may receive, from the network node, control information that schedules transmission of at least one message during an SBFD time interval in accordance with the SBFD mode, wherein the SBFD time interval at least partially overlaps in time with one or more of a DRX inactive period associated with the DRX mode or a DTX inactive period associated with the DTX mode. The reception component 1502 and/or the transmission component 1504 may communicate, with the network node, the at least one message in accordance with one or more SBFD message handling rules based at least in part on the SBFD time interval at least partially overlapping in time with one or more of the DRX inactive period or the DTX inactive period, wherein the one or more SBFD message handling rules are associated with the SBFD mode and one or more of the DRX mode or the DTX mode.

The communication manager 1506 may drop the at least one message based at least in part on the one or more SBFD message handling rules indicating that a message type associated with the at least one message cannot be transmitted during the DXX inactive period that at least partially overlaps with the SBFD time interval.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

FIG. 16 is a diagram of an example apparatus 1600 for wireless communication, in accordance with the present disclosure. The apparatus 1600 may be a network node, or a network node may include the apparatus 1600. In some aspects, the apparatus 1600 includes a reception component 1602, a transmission component 1604, and/or a communication manager 1606, which may be in communication with one another (for example, via one or more buses and/or one or more other components). In some aspects, the communication manager 1606 is the communication manager 155 described in connection with FIG. 1. As shown, the apparatus 1600 may communicate with another apparatus 1608, such as a UE or a network node (such as a CU, a DU, an RU, or a base station), using the reception component 1602 and the transmission component 1604. The communication manager 1606 may be included in, or implemented via, a processing system (for example, the processing system 145 described in connection with FIG. 1) of the network node.

In some aspects, the apparatus 1600 may be configured to perform one or more operations described herein in connection with FIGS. 3 through 12. Additionally, or alternatively, the apparatus 1600 may be configured to perform one or more processes described herein, such as process 1400 of FIG. 14. In some aspects, the apparatus 1600 and/or one or more components shown in FIG. 16 may include one or more components of the network node described in connection with FIG. 1. Additionally, or alternatively, one or more components shown in FIG. 16 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1602 may receive communications, such as reference signals, control information, data communications, or a combination thereof, from the apparatus 1608. The reception component 1602 may provide received communications to one or more other components of the apparatus 1600. In some aspects, the reception component 1602 may perform signal processing on the received communications, and may provide the processed signals to the one or more other components of the apparatus 1600. In some aspects, the reception component 1602 may include one or more components of the network node described above in connection with FIG. 1, such as a radio, one or more RF chains, one or more transceivers, or one or more modems, each of which may in turn be coupled with one or more antennas of the network node. In some aspects, the reception component 1602 and/or the transmission component 1604 may include or may be included in a network interface. The network interface may be configured to obtain and/or output signals for the apparatus 1600 via one or more communications links, such as a backhaul link, a midhaul link, and/or a fronthaul link.

The transmission component 1604 may transmit communications, such as reference signals, control information, data communications, or a combination thereof, to the apparatus 1608. In some aspects, one or more other components of the apparatus 1600 may generate communications and may provide the generated communications to the transmission component 1604 for transmission to the apparatus 1608. In some aspects, the transmission component 1604 may perform signal processing on the generated communications, and may transmit the processed signals to the apparatus 1608. In some aspects, the transmission component 1604 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1604 may be co-located with the reception component 1602.

The communication manager 1606 may support operations of the reception component 1602 and/or the transmission component 1604. For example, the communication manager 1606 may receive information associated with configuring reception of communications by the reception component 1602 and/or transmission of communications by the transmission component 1604. Additionally, or alternatively, the communication manager 1606 may generate and/or provide control information to the reception component 1602 and/or the transmission component 1604 to control reception and/or transmission of communications.

The transmission component 1604 may transmit, to a UE, information that indicates that a cell of the network node is operating in accordance with an SBFD mode. The transmission component 1604 may transmit, to the UE, configuration information that indicates a DRX mode associated with the cell and a discontinuous transmission (DTX) mode associated with the cell. The transmission component 1604 may transmit, to the UE, control information that schedules transmission of at least one message during an SBFD time interval in accordance with the SBFD mode, wherein the SBFD time interval at least partially overlaps in time with one or more of a DRX inactive period associated with the DRX mode or a DTX inactive period associated with the DTX mode. The reception component 1602 and/or the transmission component 1604 may communicate, with the UE, the at least one message in accordance with one or more SBFD message handling rules based at least in part on the SBFD time interval at least partially overlapping in time with one or more of the DRX inactive period or the DTX inactive period, wherein the one or more SBFD message handling rules are associated with the SBFD mode and one or more of the DRX mode or the DTX mode.

The communication manager 1606 may drop the at least one message based at least in part on the one or more SBFD message handling rules indicating that a message type associated with the at least one message cannot be transmitted during the DXX inactive period that at least partially overlaps with the SBFD time interval.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

The following provides an overview of some Aspects of the present disclosure:

Aspect 1: A method of wireless communication performed by a user equipment (UE), comprising: receiving, from a network node, information that indicates that a cell of the network node is operating in accordance with a subband full duplex (SBFD) mode; receiving, from the network node, configuration information that indicates a discontinuous reception (DRX) mode associated with the cell and a discontinuous transmission (DTX) mode associated with the cell; receiving, from the network node, control information that schedules transmission of at least one message during an SBFD time interval in accordance with the SBFD mode, wherein the SBFD time interval at least partially overlaps in time with one or more of a DRX inactive period associated with the DRX mode or a DTX inactive period associated with the DTX mode; and communicating, with the network node, the at least one message in accordance with one or more SBFD message handling rules based at least in part on the SBFD time interval at least partially overlapping in time with one or more of the DRX inactive period or the DTX inactive period, wherein the one or more SBFD message handling rules are associated with the SBFD mode and one or more of the DRX mode or the DTX mode.

Aspect 2: The method of Aspect 1, wherein the configuration information indicates a discontinuous transmission and reception (DXX) mode that combines the DRX mode and the DTX mode, and wherein the DRX inactive period and the DTX inactive period are included in a DXX inactive period associated with the DXX mode.

Aspect 3: The method of Aspect 2, further comprising: dropping the at least one message based at least in part on the one or more SBFD message handling rules indicating that a message type associated with the at least one message cannot be transmitted during the DXX inactive period that at least partially overlaps with the SBFD time interval.

Aspect 4: The method of Aspect 3, wherein the message type includes one or more of a semi-persistent scheduling (SPS) downlink message, a user-specific sear space (USS) physical downlink control channel (PDCCH) message, a PDCCH message associated with group-common downlink control information (DCI), a channel state information (CSI) reference signal (CSI-RS), a configured grant uplink message, an uplink scheduling request message, a sounding reference signal (SRS) not associated with positioning information, or a CSI report.

Aspect 5: The method of Aspect 2, wherein the at least one message is a sounding reference signal (SRS) that indicates positioning information, the method further comprising: transmitting, to the cell of the network node during the inactive DXX period, the at least one message based at least in part on the one or more SBFD message handling rules indicating that SRSs that indicate positioning information are allowed for transmission during the DXX inactive period that at least partially overlaps with the SBFD time interval.

Aspect 6: The method of any of Aspects 1-5, wherein the configuration information indicates independent configurations for the DRX mode and the DTX mode.

Aspect 7: The method of any of Aspects 1-6, wherein one or more SBFD symbols of the SBFD time interval overlap with the DRX inactive period, and wherein the one or more SBFD message handling rules include one or more cell DRX rules and include one or more collision handling rules.

Aspect 8: The method of Aspect 7, wherein the at least one message is semi-statically configured by a higher layer, the method further comprising: dropping the at least one message based at least in part on the one or more cell DRX rules indicating that semi-statically configured messages cannot be transmitted during the one or more SBFD symbols that overlap with the DRX inactive period.

Aspect 9: The method of Aspect 7, wherein the at least one message is dynamically scheduled, the method further comprising: transmitting, to the cell of the network node during the DRX inactive period, the at least one message based at least in part on the one or more cell DRX rules indicating that dynamically scheduled messages are allowed for transmission during the one or more SBFD symbols that overlap with the DRX inactive period.

Aspect 10: The method of Aspect 7, wherein the at least one message is an uplink message, the method further comprising: dropping the at least one message based at least in part on the one or more cell DRX rules indicating that uplink messages cannot be transmitted during the one or more SBFD symbols that overlap with the DRX inactive period.

Aspect 11: The method of Aspect 7, wherein the at least one message is an uplink message scheduled in an uplink subband of the one or more SBFD symbols, the method further comprising: dropping the at least one message based at least in part on the one or more cell DRX rules indicating that uplink messages cannot be transmitted during the one or more SBFD symbols that overlap with the DRX inactive period, wherein the one or more cell DRX rules further indicate to reconfigure the one or more SBFD symbols to one or more downlink symbols based at least in part on the one or more SBFD symbols overlapping with the DRX inactive period.

Aspect 12: The method of Aspect 7, wherein the SBFD time interval is scheduled with a set of uplink messages that at least partially overlap in time, and wherein the SBFD time interval is scheduled with a downlink message, the method further comprising: dropping one or more first uplink messages of the set of uplink messages in accordance with the one or more cell DRX rules, wherein one or more second uplink messages of the set of uplink messages that are not dropped at least partially overlaps in time with the downlink message; and determining, after dropping the one or more first uplink messages, whether to drop the one or more second uplink messages or the downlink message in accordance with the one or more collision handling rules, wherein the one or more collision handling rules prioritize transmission of dynamically scheduled messages over transmission of semi-statically scheduled messages.

Aspect 13: The method of Aspect 7, wherein the SBFD time interval is scheduled with a set of uplink messages that at least partially overlap in time, and wherein the SBFD time interval is scheduled with a downlink message, the method further comprising: determining whether to drop one or more uplink messages of the set of uplink messages or to drop the downlink message in accordance with the one or more collision handling rules, wherein the one or more collision handling rules prioritize transmission of dynamically scheduled messages over transmission of semi-statically scheduled messages; and determining, after determining whether to drop the one or more uplink messages or the downlink message, whether to drop any additional uplink messages from the set of uplink messages in accordance with the one or more cell DRX rules.

Aspect 14: The method of any of Aspects 1-13, wherein one or more SBFD symbols of the SBFD time interval overlap with the DTX inactive period, and wherein the one or more SBFD message handling rules include one or more cell DTX rules and include one or more collision handling rules.

Aspect 15: The method of Aspect 14, wherein the at least one message is semi-statically configured by a higher layer, the method further comprising: dropping the at least one message based at least in part on the one or more cell DTX rules indicating that semi-statically configured messages cannot be transmitted during the one or more SBFD symbols that overlap with the DTX inactive period.

Aspect 16: The method of Aspect 14, wherein the at least one message is dynamically scheduled, the method further comprising: receiving, from the cell of the network node during the DTX inactive period, the at least one message based at least in part on the one or more cell DTX rules indicating that dynamically scheduled messages are allowed for transmission during the one or more SBFD symbols that overlap with the DTX inactive period.

Aspect 17: The method of Aspect 14, wherein the at least one message is a downlink message, the method further comprising: dropping the at least one message based at least in part on the one or more cell DTX rules indicating that downlink messages cannot be transmitted during the one or more SBFD symbols that overlap with the DTX inactive period.

Aspect 18: The method of Aspect 14, wherein the at least one message is a downlink message scheduled in a downlink subband of the one or more SBFD symbols, the method further comprising: dropping the at least one message based at least in part on the one or more cell DTX rules indicating that downlink messages cannot be transmitted during the one or more SBFD symbols that overlap with the DTX inactive period, wherein the one or more cell DTX rules further indicate to reconfigure the one or more SBFD symbols to one or more uplink symbols based at least in part on the one or more SBFD symbols overlapping with the DTX inactive period.

Aspect 19: The method of Aspect 14, wherein the SBFD time interval is scheduled with a set of downlink messages that at least partially overlap in time, and wherein SBFD time interval is scheduled with an uplink message, the method further comprising: dropping one or more first downlink messages of the set of downlink messages in accordance with the one or more cell DTX rules, wherein one or more second downlink messages of the set of downlink messages that are not dropped at least partially overlaps in time with the uplink message; and determining, after dropping the one or more first downlink messages, whether to drop the one or more second downlink messages or the uplink message in accordance with the one or more collision handling rules, wherein the one or more collision handling rules prioritize transmission of dynamically scheduled messages over transmission of semi-statically scheduled messages.

Aspect 20: The method of Aspect 14, wherein the SBFD time interval is scheduled with a set of downlink messages that at least partially overlap in time, and wherein SBFD time interval is scheduled with an uplink message, the method further comprising: determining whether to drop one or more downlink messages of the set of downlink messages or to drop the uplink message in accordance with the one or more collision handling rules, wherein the one or more collision handling rules prioritize transmission of dynamically scheduled messages over transmission of semi-statically scheduled messages; and determining, after determining whether to drop the one or more downlink messages or the uplink message, whether to drop any additional downlink messages from the set of downlink messages in accordance with the one or more cell DTX rules.

Aspect 21: A method of wireless communication performed by a network node, comprising: transmitting, to a user equipment (UE), information that indicates that a cell of the network node is operating in accordance with a subband full duplex (SBFD) mode; transmitting, to the UE, configuration information that indicates a discontinuous reception (DRX) mode associated with the cell and a discontinuous transmission (DTX) mode associated with the cell; transmitting, to the UE, control information that schedules transmission of at least one message during an SBFD time interval in accordance with the SBFD mode, wherein the SBFD time interval at least partially overlaps in time with one or more of a DRX inactive period associated with the DRX mode or a DTX inactive period associated with the DTX mode; and communicating, with the UE, the at least one message in accordance with one or more SBFD message handling rules based at least in part on the SBFD time interval at least partially overlapping in time with one or more of the DRX inactive period or the DTX inactive period, wherein the one or more SBFD message handling rules are associated with the SBFD mode and one or more of the DRX mode or the DTX mode.

Aspect 22: The method of Aspect 21, wherein the configuration information indicates a discontinuous transmission and reception (DXX) mode that combines the DRX mode and the DTX mode, and wherein the DRX inactive period and the DTX inactive period are included in a DXX inactive period associated with the DXX mode.

Aspect 23: The method of Aspect 22, further comprising: dropping the at least one message based at least in part on the one or more SBFD message handling rules indicating that a message type associated with the at least one message cannot be transmitted during the DXX inactive period that at least partially overlaps with the SBFD time interval.

Aspect 24: The method of Aspect 23, wherein the message type includes one or more of a semi-persistent scheduling (SPS) downlink message, a user-specific sear space (USS) physical downlink control channel (PDCCH) message, a PDCCH message associated with group-common downlink control information (DCI), a channel state information (CSI) reference signal (CSI-RS), a configured grant uplink message, an uplink scheduling request message, a sounding reference signal (SRS) not associated with positioning information, or a CSI report.

Aspect 25: The method of Aspect 22, wherein the at least one message is a sounding reference signal (SRS) that indicates positioning information, the method further comprising: receiving, from the UE via the cell during the inactive DXX period, the at least one message based at least in part on the one or more SBFD message handling rules indicating that SRSs that indicate positioning information are allowed for transmission during the DXX inactive period that at least partially overlaps with the SBFD time interval.

Aspect 26: The method of any of Aspects 21-25, wherein the configuration information indicates independent configurations for the DRX mode and the DTX mode.

Aspect 27: The method of any of Aspects 21-26, wherein one or more SBFD symbols of the SBFD time interval overlap with the DRX inactive period, and wherein the one or more SBFD message handling rules include one or more cell DRX rules and include one or more collision handling rules.

Aspect 28: The method of Aspect 27, wherein the at least one message is semi-statically configured by a higher layer, the method further comprising: dropping the at least one message based at least in part on the one or more cell DRX rules indicating that semi-statically configured messages cannot be transmitted during the one or more SBFD symbols that overlap with the DRX inactive period.

Aspect 29: The method of Aspect 27, wherein the at least one message is dynamically scheduled, the method further comprising: receiving, from the UE via the cell during the DRX inactive period, the at least one message based at least in part on the one or more cell DRX rules indicating that dynamically scheduled messages are allowed for transmission during the one or more SBFD symbols that overlap with the DRX inactive period.

Aspect 30: The method of Aspect 27, wherein the at least one message is an uplink message, the method further comprising: dropping the at least one message based at least in part on the one or more cell DRX rules indicating that uplink messages cannot be transmitted during the one or more SBFD symbols that overlap with the DRX inactive period.

Aspect 31: The method of Aspect 27, wherein the at least one message is an uplink message scheduled in an uplink subband of the one or more SBFD symbols, the method further comprising: dropping the at least one message based at least in part on the one or more cell DRX rules indicating that uplink messages cannot be transmitted during the one or more SBFD symbols that overlap with the DRX inactive period, wherein the one or more cell DRX rules further indicate to reconfigure the one or more SBFD symbols to one or more downlink symbols based at least in part on the one or more SBFD symbols overlapping with the DRX inactive period.

Aspect 32: The method of Aspect 27, wherein the SBFD time interval is scheduled with a set of uplink messages that at least partially overlap in time, and wherein the SBFD time interval is scheduled with a downlink message, the method further comprising: dropping one or more first uplink messages of the set of uplink messages in accordance with the one or more cell DRX rules, wherein one or more second uplink messages of the set of uplink messages that are not dropped at least partially overlaps in time with the downlink message; and determining, after dropping the one or more first uplink messages, whether to drop the one or more second uplink messages or the downlink message in accordance with the one or more collision handling rules, wherein the one or more collision handling rules prioritize transmission of dynamically scheduled messages over transmission of semi-statically scheduled messages.

Aspect 33: The method of Aspect 27, wherein the SBFD time interval is scheduled with a set of uplink messages that at least partially overlap in time, and wherein the SBFD time interval is scheduled with a downlink message, the method further comprising: determining whether to drop one or more uplink messages of the set of uplink messages or to drop the downlink message in accordance with the one or more collision handling rules, wherein the one or more collision handling rules prioritize transmission of dynamically scheduled messages over transmission of semi-statically scheduled messages; and determining, after determining whether to drop the one or more uplink messages or the downlink message, whether to drop any additional uplink messages from the set of uplink messages in accordance with the one or more cell DRX rules.

Aspect 34: The method of any of Aspects 21-33, wherein one or more SBFD symbols of the SBFD time interval overlap with the DTX inactive period, and wherein the one or more SBFD message handling rules include one or more cell DTX rules and include one or more collision handling rules.

Aspect 35: The method of Aspect 34, wherein the at least one message is semi-statically configured by a higher layer, the method further comprising: dropping the at least one message based at least in part on the one or more cell DTX rules indicating that semi-statically configured messages cannot be transmitted during the one or more SBFD symbols that overlap with the DTX inactive period.

Aspect 36: The method of Aspect 34, wherein the at least one message is dynamically scheduled, the method further comprising: transmitting, to the UE during the DTX inactive period, the at least one message based at least in part on the one or more cell DTX rules indicating that dynamically scheduled messages are allowed for transmission during the one or more SBFD symbols that overlap with the DTX inactive period.

Aspect 37: The method of Aspect 34, wherein the at least one message is a downlink message, the method further comprising: dropping the at least one message based at least in part on the one or more cell DTX rules indicating that downlink messages cannot be transmitted during the one or more SBFD symbols that overlap with the DTX inactive period.

Aspect 38: The method of Aspect 34, wherein the at least one message is a downlink message scheduled in a downlink subband of the one or more SBFD symbols, the method further comprising: dropping the at least one message based at least in part on the one or more cell DTX rules indicating that downlink messages cannot be transmitted during the one or more SBFD symbols that overlap with the DTX inactive period, wherein the one or more cell DTX rules further indicate to reconfigure the one or more SBFD symbols to one or more uplink symbols based at least in part on the one or more SBFD symbols overlapping with the DTX inactive period.

Aspect 39: The method of Aspect 34, wherein the SBFD time interval is scheduled with a set of downlink messages that at least partially overlap in time, and wherein SBFD time interval is scheduled with an uplink message, the method further comprising: dropping one or more first downlink messages of the set of downlink messages in accordance with the one or more cell DTX rules, wherein one or more second downlink messages of the set of downlink messages that are not dropped at least partially overlaps in time with the uplink message; and determining, after dropping the one or more first downlink messages, whether to drop the one or more second downlink messages or the uplink message in accordance with the one or more collision handling rules, wherein the one or more collision handling rules prioritize transmission of dynamically scheduled messages over transmission of semi-statically scheduled messages.

Aspect 40: The method of Aspect 34, wherein the SBFD time interval is scheduled with a set of downlink messages that at least partially overlap in time, and wherein SBFD time interval is scheduled with an uplink message, the method further comprising: determining whether to drop one or more downlink messages of the set of downlink messages or to drop the uplink message in accordance with the one or more collision handling rules, wherein the one or more collision handling rules prioritize transmission of dynamically scheduled messages over transmission of semi-statically scheduled messages; and determining, after determining whether to drop the one or more downlink messages or the uplink message, whether to drop any additional downlink messages from the set of downlink messages in accordance with the one or more cell DTX rules.

Aspect 41: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-40.

Aspect 42: An apparatus for wireless communication at a device, the apparatus comprising one or more memories and one or more processors coupled to the one or more memories, the one or more processors configured to cause the device to perform the method of one or more of Aspects 1-40.

Aspect 43: An apparatus for wireless communication, the apparatus comprising at least one means for performing the method of one or more of Aspects 1-40.

Aspect 44: A non-transitory computer-readable medium storing code for wireless communication, the code comprising instructions executable by one or more processors to perform the method of one or more of Aspects 1-40.

Aspect 45: A non-transitory computer-readable medium storing a set of instructions for wireless communication, the set of instructions comprising one or more instructions that, when executed by one or more processors of a device, cause the device to perform the method of one or more of Aspects 1-40.

Aspect 46: A device for wireless communication, the device comprising a processing system that includes one or more processors and one or more memories coupled with the one or more processors, the processing system configured to cause the device to perform the method of one or more of Aspects 1-40.

Aspect 47: An apparatus for wireless communication at a device, the apparatus comprising one or more memories and one or more processors coupled to the one or more memories, the one or more processors individually or collectively configured to cause the device to perform the method of one or more of Aspects 1-40.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a +b+c, as well as any combination with multiples of the same element (for example, a+a, a+a+a, a+a+b, a+a+c, a +b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, configured to cause the UE to:
receive, from a network node, information that indicates that a cell of the network node is operating in accordance with a subband full duplex (SBFD) mode;
receive, from the network node, configuration information that indicates a discontinuous reception (DRX) mode associated with the cell and a discontinuous transmission (DTX) mode associated with the cell;
receive, from the network node, control information that schedules transmission of at least one message during an SBFD time interval in accordance with the SBFD mode, wherein the SBFD time interval at least partially overlaps in time with one or more of a DRX inactive period associated with the DRX mode or a DTX inactive period associated with the DTX mode; and
communicate, with the network node, the at least one message in accordance with one or more SBFD message handling rules based at least in part on the SBFD time interval at least partially overlapping in time with one or more of the DRX inactive period or the DTX inactive period, wherein the one or more SBFD message handling rules are associated with the SBFD mode and one or more of the DRX mode or the DTX mode.

2. The UE of claim 1, wherein the configuration information indicates a discontinuous transmission and reception (DXX) mode that combines the DRX mode and the DTX mode, and wherein the DRX inactive period and the DTX inactive period are included in a DXX inactive period associated with the DXX mode.

3. The UE of claim 2, wherein the one or more processors are further configured to cause the UE to:
drop the at least one message based at least in part on the one or more SBFD message handling rules indicating that a message type associated with the at least one message cannot be transmitted during the DXX inactive period that at least partially overlaps with the SBFD time interval.

4. The UE of claim 2, wherein the at least one message is a sounding reference signal (SRS) that indicates positioning information, and wherein the one or more processors are further configured to cause the UE to:
transmit, to the cell of the network node during the inactive DXX period, the at least one message based at least in part on the one or more SBFD message handling rules indicating that SRSs that indicate positioning information are allowed for transmission during the DXX inactive period that at least partially overlaps with the SBFD time interval.

5. The UE of claim 1, wherein one or more SBFD symbols of the SBFD time interval overlap with the DRX inactive period, and wherein the one or more SBFD message handling rules include one or more cell DRX rules and include one or more collision handling rules.

6. The UE of claim 5, wherein the at least one message is semi-statically configured by a higher layer, and wherein the one or more processors are further configured to cause the UE to:
drop the at least one message based at least in part on the one or more cell DRX rules indicating that semi-statically configured messages cannot be transmitted during the one or more SBFD symbols that overlap with the DRX inactive period.

7. The UE of claim 5, wherein the at least one message is dynamically scheduled, and wherein the one or more processors are further configured to cause the UE to:
transmit, to the cell of the network node during the DRX inactive period, the at least one message based at least in part on the one or more cell DRX rules indicating that dynamically scheduled messages are allowed for transmission during the one or more SBFD symbols that overlap with the DRX inactive period.

8. The UE of claim 5, wherein the at least one message is an uplink message, and wherein the one or more processors are further configured to cause the UE to:
drop the at least one message based at least in part on the one or more cell DRX rules indicating that uplink messages cannot be transmitted during the one or more SBFD symbols that overlap with the DRX inactive period.

9. The UE of claim 5, wherein the at least one message is an uplink message scheduled in an uplink subband of the one or more SBFD symbols, and wherein the one or more processors are further configured to cause the UE to:
drop the at least one message based at least in part on the one or more cell DRX rules indicating that uplink messages cannot be transmitted during the one or more SBFD symbols that overlap with the DRX inactive period, wherein the one or more cell DRX rules further indicate to reconfigure the one or more SBFD symbols to one or more downlink symbols based at least in part on the one or more SBFD symbols overlapping with the DRX inactive period.

10. The UE of claim 5, wherein the SBFD time interval is scheduled with a set of uplink messages that at least partially overlap in time, and wherein the SBFD time interval is scheduled with a downlink message, and wherein the one or more processors are further configured to cause the UE to:
drop one or more first uplink messages of the set of uplink messages in accordance with the one or more cell DRX rules, wherein one or more second uplink messages of the set of uplink messages that are not dropped at least partially overlaps in time with the downlink message; and
determine, after dropping the one or more first uplink messages, whether to drop the one or more second uplink messages or the downlink message in accordance with the one or more collision handling rules, wherein the one or more collision handling rules prioritize transmission of dynamically scheduled messages over transmission of semi-statically scheduled messages.

11. The UE of claim 5, wherein the SBFD time interval is scheduled with a set of uplink messages that at least partially overlap in time, and wherein the SBFD time interval is scheduled with a downlink message, and wherein the one or more processors are further configured to cause the UE to:
determine whether to drop one or more uplink messages of the set of uplink messages or to drop the downlink message in accordance with the one or more collision handling rules, wherein the one or more collision handling rules prioritize transmission of dynamically scheduled messages over transmission of semi-statically scheduled messages; and
determine, after determining whether to drop the one or more uplink messages or the downlink message, whether to drop any additional uplink messages from the set of uplink messages in accordance with the one or more cell DRX rules.

12. The UE of claim 1, wherein one or more SBFD symbols of the SBFD time interval overlap with the DTX inactive period, and wherein the one or more SBFD message handling rules include one or more cell DTX rules and include one or more collision handling rules.

13. The UE of claim 12, wherein the at least one message is semi-statically configured by a higher layer, and wherein the one or more processors are further configured to cause the UE to:
drop the at least one message based at least in part on the one or more cell DTX rules indicating that semi-statically configured messages cannot be transmitted during the one or more SBFD symbols that overlap with the DTX inactive period.

14. The UE of claim 12, wherein the at least one message is dynamically scheduled, and wherein the one or more processors are further configured to cause the UE to:
receive, from the cell of the network node during the DTX inactive period, the at least one message based at least in part on the one or more cell DTX rules indicating that dynamically scheduled messages are allowed for transmission during the one or more SBFD symbols that overlap with the DTX inactive period.

15. The UE of claim 12, wherein the at least one message is a downlink message, and wherein the one or more processors are further configured to cause the UE to:
drop the at least one message based at least in part on the one or more cell DTX rules indicating that downlink messages cannot be transmitted during the one or more SBFD symbols that overlap with the DTX inactive period.

16. The UE of claim 12, wherein the at least one message is a downlink message scheduled in a downlink subband of the one or more SBFD symbols, and wherein the one or more processors are further configured to cause the UE to:
drop the at least one message based at least in part on the one or more cell DTX rules indicating that downlink messages cannot be transmitted during the one or more SBFD symbols that overlap with the DTX inactive period, wherein the one or more cell DTX rules further indicate to reconfigure the one or more SBFD symbols to one or more uplink symbols based at least in part on the one or more SBFD symbols overlapping with the DTX inactive period.

17. The UE of claim 12, wherein the SBFD time interval is scheduled with a set of downlink messages that at least partially overlap in time, and wherein SBFD time interval is scheduled with an uplink message, and wherein the one or more processors are further configured to cause the UE to:
drop one or more first downlink messages of the set of downlink messages in accordance with the one or more cell DTX rules, wherein one or more second downlink messages of the set of downlink messages that are not dropped at least partially overlaps in time with the uplink message; and
determine, after dropping the one or more first downlink messages, whether to drop the one or more second downlink messages or the uplink message in accordance with the one or more collision handling rules, wherein the one or more collision handling rules prioritize transmission of dynamically scheduled messages over transmission of semi-statically scheduled messages.

18. The UE of claim 12, wherein the SBFD time interval is scheduled with a set of downlink messages that at least partially overlap in time, and wherein SBFD time interval is scheduled with an uplink message, and wherein the one or more processors are further configured to cause the UE to:
determine whether to drop one or more downlink messages of the set of downlink messages or to drop the uplink message in accordance with the one or more collision handling rules, wherein the one or more collision handling rules prioritize transmission of dynamically scheduled messages over transmission of semi-statically scheduled messages; and
determine, after determining whether to drop the one or more downlink messages or the uplink message, whether to drop any additional downlink messages from the set of downlink messages in accordance with the one or more cell DTX rules.

19. A method of wireless communication performed by a user equipment (UE), comprising:
receiving, from a network node, information that indicates that a cell of the network node is operating in accordance with a subband full duplex (SBFD) mode;
receiving, from the network node, configuration information that indicates a discontinuous reception (DRX) mode associated with the cell and a discontinuous transmission (DTX) mode associated with the cell;
receiving, from the network node, control information that schedules transmission of at least one message during an SBFD time interval in accordance with the SBFD mode, wherein the SBFD time interval at least partially overlaps in time with one or more of a DRX inactive period associated with the DRX mode or a DTX inactive period associated with the DTX mode; and
communicating, with the network node, the at least one message in accordance with one or more SBFD message handling rules based at least in part on the SBFD time interval at least partially overlapping in time with one or more of the DRX inactive period or the DTX inactive period, wherein the one or more SBFD message handling rules are associated with the SBFD mode and one or more of the DRX mode or the DTX mode.

20. An apparatus for wireless communication, comprising:
means for receiving, from a network node, information that indicates that a cell of the network node is operating in accordance with a subband full duplex (SBFD) mode;
means for receiving, from the network node, configuration information that indicates a discontinuous reception (DRX) mode associated with the cell and a discontinuous transmission (DTX) mode associated with the cell;
means for receiving, from the network node, control information that schedules transmission of at least one message during an SBFD time interval in accordance with the SBFD mode, wherein the SBFD time interval at least partially overlaps in time with one or more of a DRX inactive period associated with the DRX mode or a DTX inactive period associated with the DTX mode; and
means for communicating, with the network node, the at least one message in accordance with one or more SBFD message handling rules based at least in part on the SBFD time interval at least partially overlapping in time with one or more of the DRX inactive period or the DTX inactive period, wherein the one or more SBFD message handling rules are associated with the SBFD mode and one or more of the DRX mode or the DTX mode.
